(19) United States
(12) Patent Application Publication
(10) Pub. No.: US 2026/0031902 A1
(43) Pub. Date: Jan. 29, 2026

(54) COMMUNICATION METHOD, COMMUNICATION APPARATUS, COMMUNICATION SYSTEM, MEDIUM, CHIP, AND PROGRAM PRODUCT

(71) Applicant: HUAWEI TECHNOLOGIES CO., LTD., Shenzhen (CN)

(72) Inventors: Hejia LUO, Ottawa (CA); Xian MENG, Hangzhou (CN); Yu WANG, Hangzhou (CN); Jun WANG, Hangzhou (CN); Chuili KONG, Hangzhou (CN); Xiaolu WANG, Hangzhou (CN)

(73) Assignee: HUAWEI TECHNOLOGIES CO., LTD., Shenzhen (CN)

(21) Appl. No.: 19/345,414

(22) Filed: Sep. 30, 2025

Related U.S. Application Data
(63) Continuation of application No. PCT/CN2024/079996, filed on Mar. 4, 2024.

(30) Foreign Application Priority Data
Mar. 31, 2023 (CN) 202310379163.4

(51) Int. Cl. H04B 7/185

(52) U.S. Cl. CPC H04B 7/18541; H04B 7/18521; H04B 7/18547

(57) ABSTRACT

A communication method and a communication apparatus. The communication method includes: a first communication apparatus receives configuration information from a second communication apparatus, where the configuration information indicates at least one satellite group and at least one ground area unit associated with the at least one satellite group. The communication method further includes: the first communication apparatus performs switching between a plurality of satellites in a satellite group in the at least one satellite group based on the configuration information, where the first communication apparatus is in a ground area unit associated with the satellite group.

### CROSS-REFERENCE TO RELATED APPLICATIONS

This application is a continuation of International Application No. PCT/CN2024/079996, filed on Mar. 4, 2024, which claims priority to Chinese Patent Application No. 202310379163.4, filed on Mar. 31, 2023. The disclosures of the aforementioned applications are hereby incorporated by reference in their entireties.

### TECHNICAL FIELD

The embodiments relate to the communication field, and a communication method, a communication apparatus, a communication system, a computer-readable storage medium, a chip, and a computer program product.

### BACKGROUND

(Very) Low earth orbit ((V)LEO) satellite communication has received wide attention in recent years. In recent years, large (V)LEO constellations have been planned and deployed, and high-density (V)LEO constellations have become a trend. Currently, a quantity of orbits of each layer of satellites and a quantity of satellites in each orbit are increased significantly, and a plurality of layers of satellites tends to be deployed. A terminal device or a user equipment (UE) on the ground can view a plurality of satellites. A visible area of each satellite (that is, an area in which the satellite provides a communication service, sometimes also referred to as a “serving area”) has large-scale overlapping. In view of this, the serving area of each satellite may be “narrowed” or simple multi-coverage of serving areas of a plurality of satellites is used, to reduce large-scale overlapping of serving areas of satellites.

However, when the serving area of each satellite is “narrowed”, each satellite reduces a beam sweeping angle, and a ground capacity density is increased. However, a switching frequency is further increased, and very high switching overheads are caused to a system. In the case of simple multi-coverage, each satellite directly covers the ground in an overlapping manner without narrowing a beam sweeping angle. Therefore, a switching frequency can be maintained, but inter-satellite interference (that is, interference between adjacent satellites) is caused, and a ground capacity is difficult to increase effectively, and even may be decreased due to interference.

### SUMMARY

In view of this, the embodiments provide a communication method, a communication apparatus, a communication system, a computer-readable storage medium, a chip, and a computer program product.

According to a first aspect, a communication method is provided. The method includes: a first communication apparatus receives configuration information from a second communication apparatus, where the configuration information indicates at least one satellite group and at least one ground area unit associated with the at least one satellite group. The first communication apparatus performs switching between a plurality of satellites in a satellite group in the at least one satellite group based on the configuration information, where the first communication apparatus is in a ground area unit associated with the satellite group. In this way, frequent switching in a large constellation can be reduced, and frequencies of inter-group switching and intra-group switching of a satellite group can be decoupled from a scale of satellites before grouping, and are always kept in a low range. In addition, inter-satellite interference can be effectively reduced to effectively increase a ground capacity.

In some embodiments of the first aspect, the first communication apparatus includes one of the following: a terminal device; or a chip in a terminal device. In this way, the first communication apparatus can be implemented in a plurality of forms based on requirements in various application scenarios, to implement a function of the first communication apparatus.

According to a second aspect, a communication method is provided. For beneficial effects, refer at least to the descriptions of the first aspect. Details are not described herein again. The communication method includes: a second communication apparatus obtains information indicating at least one satellite group and at least one ground area unit associated with the at least one satellite group. The second communication apparatus performs switching of a first communication apparatus between a plurality of satellites in a satellite group in the at least one satellite group based on the information, where the first communication apparatus is in a ground area unit associated with the satellite group.

In some embodiments of the second aspect, that the second communication apparatus obtains the information includes: the second communication apparatus receives configuration information from a third communication apparatus, where the configuration information indicates the at least one satellite group and the at least one ground area unit associated with the at least one satellite group.

In some embodiments of the second aspect, the communication method further includes: The second communication apparatus sends the configuration information to the first communication apparatus.

In some embodiments of the second aspect, the switching includes at least one of the following: switching between two satellite groups in the at least one satellite group; or switching between two satellites in one of the at least one satellite group.

According to a third aspect, a communication method is provided. For beneficial effects, refer at least to the descriptions of the first aspect. Details are not described herein again. The communication method includes: a third communication apparatus divides a plurality of satellites into at least one satellite group. The third communication apparatus determines at least one ground area unit associated with the at least one satellite group. The third communication apparatus sends configuration information to a second communication apparatus, where the configuration information indicates the at least one satellite group and the at least one associated ground area unit.

In some embodiments of the first aspect, the second aspect, and the third aspect, the at least one satellite group has different latitudes of coverage areas.

In some embodiments of the first aspect, the second aspect, and the third aspect, the at least one satellite group includes an intra-orbit satellite group and an inter-orbit satellite group, satellites in the intra-orbit satellite group belong to a same orbit, and satellites in the inter-orbit satellite group belong to at least two different orbits.

In some embodiments of the first aspect, the second aspect, and the third aspect, satellites in a satellite group in the at least one satellite group meet at least one of the following: a difference between altitudes is lower than a threshold; a difference between inclinations is lower than a threshold; all are in an ascending orbit or all are in a descending orbit; a difference between switching intervals is lower than a threshold; a difference between intra-orbit spacings is lower than a threshold; a difference between inter-orbit spacings is lower than a threshold; a difference between loads is lower than a threshold; or satellites in the satellite group are capable of establishing an inter-satellite link.

In some embodiments of the first aspect, the second aspect, and the third aspect, the plurality of satellites belongs to a same large constellation, each of the at least one satellite group has a same quantity of orbits and a same quantity of satellites in each orbit, a quantity of orbits of the large constellation is divisible by the quantity of orbits of each satellite group, and a quantity of satellites in each orbit of the large constellation is divisible by the quantity of satellites in each orbit of each satellite group.

In some embodiments of the first aspect, the second aspect, and the third aspect, the quantity of orbits of the large constellation is M1, and the quantity of satellites in each of the M1 orbits is N1, where M1 and N1 are natural numbers; and a size of each of the at least one satellite group is M2×N2, where M1 mod M2=0, N1 mod N2=0, M2 represents the quantity of orbits of each satellite group, N2 represents the quantity of satellites in each orbit of each satellite group, and mod represents a modulo operation.

In some embodiments of the first aspect, the second aspect, and the third aspect, a quantity of the at least one satellite group is (M1×N1)/(M2×N2)×2, where “×2” represents that a satellite in an ascending orbit and a satellite in a descending orbit belong to different satellite groups.

In some embodiments of the first aspect, the second aspect, and the third aspect, satellites at different layers belong to different satellite groups.

In some embodiments of the first aspect, the second aspect, and the third aspect, for a satellite group in the at least one satellite group, a correspondence between the ground area unit and an orbit to which a satellite in the satellite group belongs is based on a distance between a reference position of a ground area unit in the at least one ground area unit and the orbit; and a correspondence between the ground area unit and the satellite group is based on a distance between the reference position and the satellite group.

In some embodiments of the first aspect, the second aspect, and the third aspect, the ground area unit and the orbit meet one of the following: a correspondence between the ground area unit and the orbit is based on a distance between the reference position and the orbit being less than or equal to a first distance threshold; or a non-correspondence between the ground area unit and the orbit is based on a distance between the reference position and the orbit being greater than a first distance threshold.

In some embodiments of the first aspect, the second aspect, and the third aspect, the ground area unit and the satellite in the satellite group meet at least one of the following: a correspondence between the ground area unit and the satellite in the satellite group is based on a distance between the reference position and the satellite in the satellite group being less than or equal to a second distance threshold, where the satellite in the satellite group provides a communication service for a first communication apparatus in the ground area unit; or a non-correspondence between the ground area unit and the satellite in the satellite group is based on a distance between the reference position and the satellite in the satellite group being greater than a second distance threshold, where the satellite in the satellite group does not provide a communication service for a first communication apparatus in the ground area unit.

In some embodiments of the first aspect, the second aspect, and the third aspect, the distance between the reference position and the satellite group is a distance between the reference position and a central position of the satellite group, and the reference position is a central point of the ground area unit.

In some embodiments of the first aspect, the second aspect, and the third aspect, the configuration information includes at least one of the following: a ground area unit served by a satellite in the satellite group in the at least one satellite group; or a trigger rule for switching of the satellite group.

In some embodiments of the first aspect, the second aspect, and the third aspect, the trigger rule includes at least one of the following: a latitude of a position of the first communication apparatus in the ground area unit exceeds a threshold; the satellite in the satellite group switches between an ascending orbit and a descending orbit relative to a movement trajectory of the first communication apparatus in the ground area unit; or time during which the satellite group provides the communication service for the first communication apparatus in the ground area unit exceeds a threshold.

In some embodiments of the first aspect, the second aspect, and the third aspect, a length of the ground area unit in the at least one ground area unit in a movement direction of a first satellite in the satellite group in the at least one satellite group is not greater than half of an overlapping area of coverage areas of two adjacent satellites in an orbit to which the first satellite belongs before the first satellite is grouped.

In some embodiments of the first aspect, the second aspect, and the third aspect, a length of the ground area unit in the at least one ground area unit in an earth rotation direction is not greater than half of an overlapping area of coverage areas of two adjacent satellites in an orbit to which a second satellite belongs before the second satellite in the satellite group in the at least one satellite group is grouped.

According to a fourth aspect, a first communication apparatus is provided. The first communication apparatus includes: a memory, configured to store a computer program; and a processor, configured to execute the computer program stored in the memory, so that the first communication apparatus implements the method according to any possible implementation of the first aspect.

According to a fifth aspect, a second communication apparatus is provided. The second communication apparatus includes: a memory, configured to store a computer program; and a processor, configured to execute the computer program stored in the memory, so that the second communication apparatus implements the method according to any possible implementation of the second aspect.

According to a sixth aspect, a third communication apparatus is provided. The third communication apparatus includes: a memory, configured to store a computer program; and a processor, configured to execute the computer program stored in the memory, so that the third communication apparatus implements the method according to any possible implementation of the third aspect.

According to a seventh aspect, a communication system is provided. The communication system includes a first communication apparatus, a second communication apparatus, and a third communication apparatus, and is configured to implement the method according to any possible implementation of the first aspect, the second aspect, or the third aspect by using the first communication apparatus, the second communication apparatus, and the third communication apparatus.

According to an eighth aspect, a computer-readable storage medium is provided. The computer-readable storage medium stores a computer program. When the computer program is executed by a processor, the method according to any possible implementation of the first aspect, the second aspect, or the third aspect is implemented.

According to a ninth aspect, a chip is provided. The chip includes a processing circuit, configured to perform the method according to any possible implementation of the first aspect, the second aspect, or the third aspect.

According to a tenth aspect, a computer program product is provided. The computer program product is tangibly stored on a computer-readable medium and includes computer-executable instructions. When the computer-executable instructions are executed, a device is enabled to implement the method according to any possible implementation of the first aspect, the second aspect, or the third aspect.

According to the embodiments, frequent switching in the large constellation can be reduced, and frequencies of inter-group switching and intra-group switching of the satellite group can be decoupled from the scale of the satellites before grouping, and are always kept in the low range. In addition, inter-satellite interference can be effectively reduced to effectively increase the ground capacity.

The summary part is provided to describe related concepts in a simplified form. The concepts are further described in the following description of the embodiments. The summary part is not intended to identify key features or main features, and is not intended to limit the scope of the embodiments.

### BRIEF DESCRIPTION OF THE DRAWINGS

Features, advantages, and other aspects of implementations of example solutions become more apparent with reference to the accompanying drawings and the following detailed descriptions. Several implementations of the example solutions are shown herein by way of example but not limitation. In the accompanying drawings:

FIG. 1A is a block diagram of a communication system in which the embodiments may be implemented;

FIG. 1B is a diagram of a communication system in a transparent mode (transparent mode) in which the embodiments may be implemented;

FIG. 1C is a diagram of a communication system in a regenerative mode (regenerative mode) in which the embodiments may be implemented;

FIG. 2 is a signaling exchange diagram of a communication process according to example implementations of some embodiments;

FIG. 3A is a diagram of a satellite group associated with a ground area unit according to example implementations of some embodiments;

FIG. 3B is a diagram of another satellite group associated with a ground area unit according to example implementations of some embodiments;

FIG. 3C is a diagram of another satellite group associated with a ground area unit according to example implementations of some embodiments;

FIG. 3D is a diagram of another satellite group associated with a ground area unit according to example implementations of some embodiments;

FIG. 3E is a diagram of a plurality of satellite groups associated with a ground area unit according to example implementations of some embodiments;

FIG. 3F is a diagram of association between a ground area unit and a satellite group according to example implementations of some embodiments;

FIG. 4A is a diagram of a converged network architecture in a transparent mode according to example implementations of some embodiments;

FIG. 4B is a diagram of a converged network architecture in a regenerative mode according to example implementations of some embodiments;

FIG. 5 is a diagram of a communication process according to example implementations of some embodiments;

FIG. 6 is a flowchart of a method implemented at a first communication apparatus according to some embodiments;

FIG. 7 is a flowchart of a method implemented at a second communication apparatus according to some embodiments;

FIG. 8 is a flowchart of a method implemented at a third communication apparatus according to some embodiments;

FIG. 9 is a block diagram of a first communication apparatus according to some embodiments;

FIG. 10 is a block diagram of a second communication apparatus according to some embodiments;

FIG. 11 is a block diagram of a third communication apparatus according to some embodiments; and

FIG. 12 is a simplified block diagram of an example device suitable for implementing embodiments.

In the accompanying drawings, same or similar reference numerals represent same or similar elements.

### DETAILED DESCRIPTION OF THE EMBODIMENTS

The following describes the embodiments in more detail with reference to the accompanying drawings. Although some embodiments are shown in the accompanying drawings, it should be understood that the embodiments may be implemented in various forms and should not be construed as being limited to embodiments described herein, and instead, these embodiments are provided for a more thorough and complete understanding. It should be understood that, the accompanying drawings and embodiments are merely used as examples, but are not used to limit the scope of the embodiments.

In the descriptions of the embodiments, the term “include” and similar terms thereof should be understood as open inclusion, for example “include but not limited to”. The term “based on” should be understood as “at least partially based on”. The term “one embodiment” or “this embodiment” should be understood as “at least one embodiment”. In the embodiments, for a type of feature, “first”, “second”, “third”, and the like are used to distinguish between features in the type of feature, and there is no time or magnitude order between the features described by “first”, “second”, and “third”. The following may further include other explicit and implied definitions.

Depending on the context, for example, words “if” used herein may be explained as “while” or “when” or “in response to determining” or “in response to detection”. Similarly, depending on the context, phrases “if determining” or “if detecting (a stated condition or event)” may be explained as “when determining” or “in response to determining” or “when detecting (the stated condition or event)” or “in response to detecting (the stated condition or event)”.

The accompanying drawings show various diagrams of structures according to embodiments. These diagrams are not drawn to scale. For the purpose of clarity, some details are magnified and some details may be omitted. Shapes of various areas and layers shown in the diagrams and relative sizes and position relationships between the areas and the layers are merely examples. There may be deviations due to manufacturing tolerances or limitations in practice. In addition, a person skilled in the art may additionally design areas/layers with different shapes, sizes, and relative positions based on actual requirements.

The embodiments may be implemented according to any appropriate communication protocol, including but not limited to cellular communication protocols such as 3rd generation (3G), 4th generation (4G), 5th generation (5G), and a future communication protocol (for example, 6th generation (6G)), a wireless local area network communication protocol such as the Institute of Electrical and Electronics Engineers (IEEE) 802.11, the 3rd generation partnership project (3GPP), and/or any other protocol known currently or developed in the future.

The embodiments are applied to a communication system that complies with any appropriate communication protocol, for example, a general packet radio service (GPRS) system, a global system for mobile communications (GSM), an enhanced data rate for GSM evolution (EDGE) system, a universal mobile telecommunications system (UMTS), a long term evolution (LTE) system, a wideband code division multiple access (WCDMA) system, a code division multiple access 2000 (CDMA2000) system, a time division-synchronization code division multiple access (TD-SCDMA) system, a frequency division duplex (FDD) system, a time division duplex (TDD) system, a 5th generation (5G) system (for example, a new radio (NR) system), and a future communication system (for example, a 6th generation (6G) system). The embodiments may be further applied to end to end (E2E) communication, device to device (D2D) communication, vehicle-to-everything (V2X) communication, machine to machine (M2M) communication, machine type communication (MTC), an internet of things (IoT) communication system, or another communication system.

For the purpose of illustration, the following describes the embodiments in a background of a 5G communication system. However, it should be understood that the embodiments are not limited to the communication system, but may be applied to any communication system having a similar problem, for example, a wireless local area network (WLAN), a wired communication system, or another communication system developed in future.

The term “terminal device” is any terminal device that can perform wired or wireless communication with a network device or between terminal devices. The terminal device may sometimes be referred to as a user equipment (UE), an application terminal, an access terminal, a subscriber unit, a subscriber station, a mobile station, a remote station, a remote terminal, a mobile device, a user terminal, a terminal, a wireless communication device, a user agent, or a user apparatus. Currently, some examples of the terminal device are as follows: a mobile phone, a tablet computer, a notebook computer, a palmtop computer, a mobile internet device (MID), a wearable device, a virtual reality (VR) device, an augmented reality (AR) device, a wireless terminal in industrial control, a wireless terminal in self-driving, a wireless terminal in remote medical surgery, a wireless terminal in a smart grid, a wireless terminal in transportation safety, a wireless terminal in a smart city, a wireless terminal in a smart home, a cellular phone, a cordless phone, a session initiation protocol (SIP) phone, a wireless local loop (WLL) station, a personal digital assistant (PDA), a handheld device having a wireless communication function, a computing device or another processing device connected to a wireless modem, a wearable device, a terminal device in a 5G network, a terminal device in a future evolved public land mobile communication network (PLMN), and the like. This is not limited in the embodiments. By way of example and not limitation, the terminal device in the embodiments may alternatively be a terminal device in an IoT system. An IoT is an important part of future development of information technologies. A feature of the IoT is connecting a thing to a network by using a communication technology, to implement an intelligent network for interconnection between a person and a machine or between one thing and another. It may be understood that the terminal device in the embodiments may be a terminal that implements an application, for example, a terminal having a camera function, or a terminal that may perform data transmission. In the embodiments, an apparatus configured to implement a function of the terminal device may be a terminal device; or may be an apparatus, for example, a chip system or a chip, that can support a terminal device in implementing the function, and the apparatus may be mounted in the terminal device. In the embodiments, the chip system may include a chip, or may include a chip and another discrete device.

The term “network device” is an entity or a node that may be configured to communicate with a terminal device, for example, may be an access network device. The access network device may be an apparatus that is deployed in a radio access network and that provides a wireless communication function for a mobile terminal. For example, the access network device may be a radio access network (RAN) network device. The access network device may include various types of base stations. The base station is configured to provide a wireless access service for the terminal device. For example, each base station corresponds to a service coverage area, and a terminal device entering the area may communicate with the base station by using a wireless signal, to receive a wireless access service provided by the base station. The service coverage areas of the base stations may overlap, and a terminal device in an overlapping area may receive wireless signals from a plurality of base stations. Therefore, the plurality of base stations may simultaneously provide services for the terminal device. Based on a size of the provided service coverage area, the access network device may include a macro base station providing a macro cell, a micro base station providing a micro cell, a pico base station providing a pico cell, and a femto base station providing a femto cell. In addition, the access network device may further include various forms of relay stations, access points, remote radio units (RRU), radio frequency heads (RH), remote radio heads (RRH), and the like. In systems using different radio access technologies, the access network device may have different names. For example, the access network device is referred to as an evolved NodeB (eNB) in a long term evolution (LTE) system network, is referred to as a NodeB (NB) in a 3G network, and may be referred to as a gNodeB (gNB) or an NR NodeB (NR NB) in the 5G network. In some scenarios, the access network device may include a central unit (CU) and/or a distributed unit (DU). The CU and DU may be deployed in different places. For example, the DU is remotely deployed in a high-traffic area, and the CU is deployed in a central equipment room. Alternatively, the CU and the DU may be deployed in a same equipment room. The CU and the DU may alternatively be different components on one rack. For ease of description, in the following embodiments, the foregoing apparatuses that provide the wireless communication function for the mobile terminal are collectively referred to as the network device. This is not limited.

Currently, 5G new radio (NR) has entered a deployment phase from a standardization phase. An NR standard is researched and designed based on characteristics of terrestrial communication, and has a characteristic of providing high-rate, high-reliability, and low-latency communication for a user terminal. Compared with the terrestrial communication, non-terrestrial network (NTN) communication has characteristics such as a large coverage area and flexible networking. Currently, research institutes, communication organizations, companies, and the like all participate in research on NTN communication technologies and standards, and intend to build a unified communication network for space-air-ground communication.

The NTN communication includes networking by using devices such as an uncrewed aerial vehicle, a high-altitude platform, and a satellite, to provide services such as data transmission and voice communication for a user equipment (UE). An altitude of a high altitude platform system (HAPS) device can be 8 kilometers to 50 kilometers (km) above the ground. Based on an orbital altitude of a satellite, satellite communication systems may be classified into three types: a geostationary earth orbit (GEO) satellite communication system, also referred to as a synchronous orbit satellite system, a medium earth orbit (MEO) satellite communication system, and a low earth orbit (LEO) satellite communication system. A GEO satellite has an orbital altitude of approximately 35,786 km. A main advantage is that the GEO satellite can remain stationary relative to the ground and provide a large coverage area. However, GEO satellite communication also has definite disadvantages. In one aspect, a GEO satellite orbit is far away from the earth, and a free space propagation loss is large, which results in a tight communication link budget. To increase a transmitting/receiving gain, the satellite needs to be configured with an antenna with a large aperture. In another aspect, a transmission delay of GEO satellite communication is large, and a round-trip delay may reach about 500 milliseconds, which cannot meet a requirement of a real-time service. In addition, GEO orbital resources are limited, launch costs are high, and coverage cannot be provided for polar areas of the earth. An MEO satellite has an orbital altitude of 2,000 km to 35,786 km. An advantage is that global coverage can be implemented by using a smaller quantity of satellites. However, the MEO satellite has a higher orbital altitude than the LEO, and a transmission delay is still larger than that of LEO satellite communication. Based on the advantage and disadvantage of MEO satellite communication, the MEO satellite can be used for positioning and navigation. An LEO satellite has an orbital altitude of 300 km to 2,000 km. The LEO satellite has a lower orbit altitude than the MEO and the GEO, and has advantages of a small data transmission delay, a small transmission loss, and low launch costs. Therefore, the LEO satellite communication has also gained wide attention in recent years.

In addition, the satellite device is limited by manufacturing and launch costs, and a data processing capability and a transmit power on the satellite are also limited. Currently, a satellite communication network cannot provide the UE with a communication rate comparable to that of a terrestrial communication network. To break through this limitation and improve the overall signal processing capability and communication throughput of the satellite network, satellite operators are preparing to launch the mega low-orbit constellation, for example to increase a quantity of satellites to compensate for the limitation of a communication capability of a single satellite. In a future NTN communication system, after a UE accesses a system, a plurality of satellites that can perform communication may be “visible” to the UE within a period of time. In this case, the plurality of satellites may provide a communication service for the UE. This provides a basic condition for multi-satellite coordinated transmission.

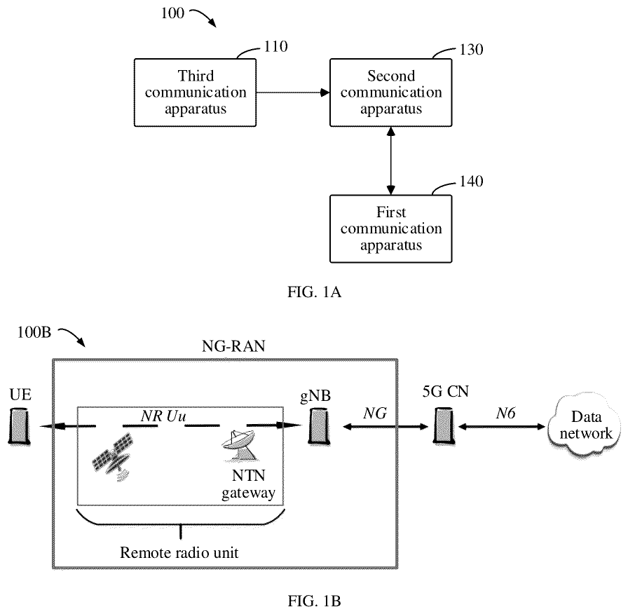

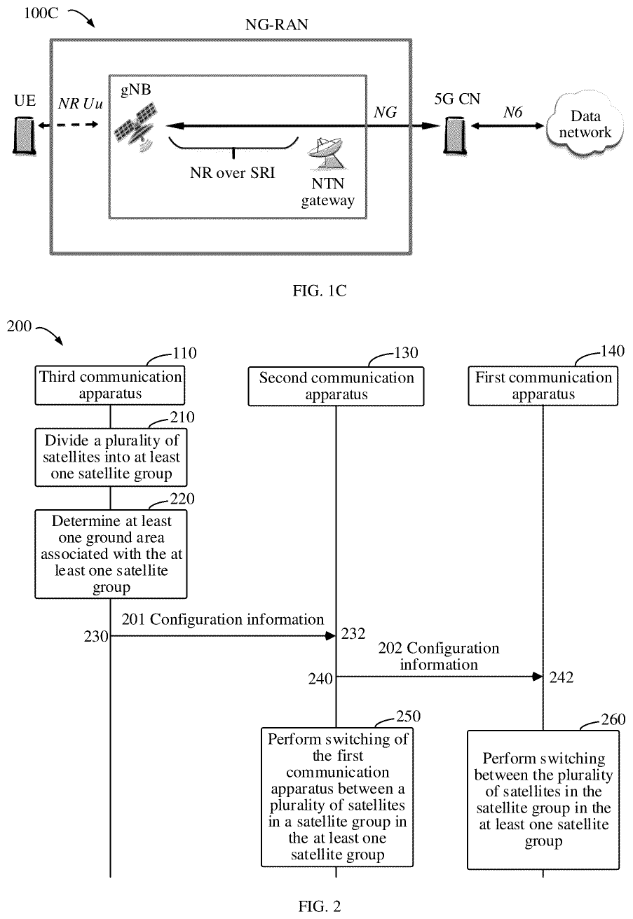

The NTN network has two common architectures: a regenerative architecture and a transparent architecture based on different load types. In the transparent architecture, a visible base station is on the ground, and further descriptions are provided later with reference to FIG. 1B. In the regenerative architecture, some functions of a visible base station are implemented on the satellite, and further descriptions are provided later with reference to FIG. 1C.

A movement speed of a low-orbit satellite is about 7.5 km/s to 7.8 km/s at different orbital altitudes. When a satellite is far away from a specific area, a subsequent satellite needs to take over to serve the area. A switching frequency of a conventional low-orbit satellite constellation that meets a global coverage requirement is about 5 minutes to 10 minutes. Herein, a satellite constellation is a set of satellites that collaboratively complete a specific task according to a specific spatial geometric configuration. A satellite constellation configuration may include an orbit type of a satellite, spatial distribution, and an inter-satellite relationship.

After the satellite constellation is encrypted, a visible area of each satellite has large-scale overlapping. How to plan a serving area of each satellite becomes an important issue. Currently, two existing methods are not good enough. A first method is to “narrow” a serving area of each satellite, for example each satellite narrows a beam sweeping angle. In this case, a ground capacity density increases, but a switching frequency further increases. A large-scale constellation is used as an example. A switching interval of a single layer of constellation is as low as 40 seconds(s) to 1 minute, which causes high switching overheads to a system. This method causes frequent switching, and increases overheads.

Another method is simple multi-coverage. For example, each satellite directly covers the ground in an overlapping manner without narrowing a beam sweeping angle. In this case, a switching frequency can be maintained. However, simple multi-coverage causes inter-satellite interference, and a ground capacity is difficult to increase effectively, and even may be decreased due to interference. This method causes large-scale inter-satellite interference, which makes it difficult to increase the capacity with an increase in a quantity of satellites.

In view of this, an embodiment provides a communication method. In the communication method, a mapping relationship between a “ground area unit and a satellite” is properly planned, so that a terminal device stays in a coverage area of each satellite for as long as possible. Therefore, regardless of signaling overheads in a switching process specified in a communication protocol, switching overheads can be reduced proportionally. According to the method, the terminal device stays in the coverage area of each satellite for similar time, so that loads of satellites are balanced, and configuration is easier. In the embodiments, the terminal device may be located on the ground, or may be located in a flight vehicle such as an aircraft (including an uncrewed aerial vehicle). An area in which the flight vehicle such as the aircraft is located is considered as a ground area. In this way, frequent switching in a large constellation can be reduced, and frequencies of inter-group switching and intra-group switching of a satellite group can be decoupled from a scale of satellites before grouping, and are always kept in a low range. In addition, inter-satellite interference can be effectively reduced to effectively increase a ground capacity.

As described above, the NTN network has the two common architectures: the regenerative architecture and the transparent architecture based on different load types. In the transparent architecture, the visible base station is on the ground. In the regenerative architecture, (some) functions of the visible base station are implemented on the satellite. The following provides descriptions with reference to FIG. 1A, FIG. 1B, and FIG. 1C.

FIG. 1A is a block diagram of a communication system 100A in which the embodiments may be implemented. As shown in FIG. 1A, the communication system 100A is a part of a network, and includes a third communication apparatus 110, a second communication apparatus 130, and a first communication apparatus 140. For example, the third communication apparatus may be a network control unit, and has a capability of properly planning a mapping relationship between a “ground area unit and a satellite”. The second communication apparatus may be a base station, and the first communication apparatus may be a terminal device (UE). The third communication apparatus 110 is communicatively connected to the second communication apparatus 130. The second communication apparatus 130 and the first communication apparatus 140 may perform bidirectional communication. A satellite (not shown) and the second communication apparatus 130 may perform bidirectional communication. It should be noted that FIG. 1 shows only one second communication apparatus 130 and one first communication apparatus 140. However, a quantity of second communication apparatuses 130 and a quantity of first communication apparatuses 140 in the communication system 100A are not limited thereto. Alternatively, there may be a plurality of second communication apparatuses 130 and a plurality of first communication apparatuses 140.

FIG. 1B is a diagram of a communication system 100B in a transparent mode in which the embodiments may be implemented. As shown in FIG. 1, the communication system 100B is a part of a network. The communication system 100B belongs to a transparent satellite network architecture, and includes a terminal device UE, a satellite, an NTN gateway, a gNB, a 5G CN, and a data network. The satellite communicates with the NTN gateway through an NR Uu interface, and the satellite and the NTN gateway form a remote radio unit (RRU). The satellite, the NTN gateway, and the gNB form an NG-RAN. The satellite transparently transmits, to the UE, signaling and/or data from the gNB that are/is sent via the NTN gateway, and transparently transmits, to the gNB via the NTN gateway, signaling and/or data from the UE. The gNB is connected to the data network through the 5G CN. In actual deployment, the satellite in FIG. 1B may alternatively be replaced with another NTN device such as a HAPS.

FIG. 1C is a diagram of a communication system 100C in a regenerative mode in which the embodiments may be implemented. As shown in FIG. 1C, the communication system 100C is a part of a network. The communication system 100C belongs to a regenerative satellite network architecture, and includes a terminal device UE, a satellite, an NTN gateway, a 5G CN, and a data network. The satellite functions as a base station in a RAN, communicates with the UE through an NR Uu interface, and receives downlink data and/or sends uplink data through an “NG over SRI” (NG over SRI). The satellite and the NTN gateway form an NG-RAN. In actual deployment, the satellite in FIG. 1C may alternatively be replaced with another NTN device such as a HAPS.

In recent years, large (V)LEO constellations have been planned and deployed, and high-density (V)LEO constellations have become a trend. A quantity of orbits of each layer of satellites and a quantity of satellites in each orbit are increased significantly, and a plurality of layers of satellites tends to be deployed, so that a plurality of satellites is visible to a UE on the ground, for example the UE on the ground can accept communication services from the plurality of satellites simultaneously. Table 1 shows a diagram of parameters 100D of a plurality of layers of constellations in which the embodiments may be implemented. The plurality of layers of constellations shown in Table 1 include nine layers of satellite constellations, and a quantity of satellites at each layer ranges from hundreds to thousands. As shown in Table 1, each layer of satellite constellation (sometimes also referred to as a “large constellation” below) corresponds to one altitude and one inclination, for example satellites with a same altitude and a same inclination form one satellite constellation. The plurality of layers of constellations including the nine layers of satellite constellations shown in Table 1 are sometimes also referred to as large-scale constellations or mega constellations. The large-scale constellation can significantly increase the capacity of the terrestrial network.

TABLE 1

| | | Orbital | Quantity of satellites | Total quantity |
|---|---|---|---|---|
| Altitude | Inclination | plane | per orbital plane | of satellites |
| 340 | 53 | 48 | 110 | 5,280 |
| 345 | 46 | 48 | 110 | 5,280 |
| 350 | 38 | 48 | 110 | 5,280 |
| 360 | 96.9 | 30 | 120 | 3,600 |
| 525 | 53 | 28 | 120 | 3,360 |
| 530 | 43 | 28 | 120 | 3,360 |
| 535 | 33 | 28 | 120 | 3,360 |
| 604 | 148 | 12 | 12 | 144 |
| 614 | 115.7 | 18 | 18 | 324 |

As shown in Table 1, a 1^{st} layer of satellite constellation has 48 orbits with an altitude of 340 km, an inclination of 53°, and 110 satellites in each orbit. Therefore, there are 5280 (=48×110) satellites in total in the 1^{st} layer of satellite constellation. Similarly, the 5th layer of satellite constellation has 28 orbits with an altitude of 525 km, an inclination of 53°, and 120 satellites in each orbit. Therefore, there are 3360 (=28×120) satellites in total in the 5th layer of satellite constellation. A 9th layer of satellite constellation has 18 orbits with an altitude of 614 km, an inclination of 115.7°, and 18 satellites in each orbit. Therefore, there are 324 (=18×18) satellites in total in the 9^{th} layer of satellite constellation.

FIG. 2 is a signaling exchange diagram of a communication process 200 according to example implementations of some embodiments. The communication process 200 relates to a first communication apparatus, a second communication apparatus, and a third communication apparatus. The first communication apparatus is, for example, the first communication apparatus 140 shown in FIG. 1, the second communication apparatus is, for example, the second communication apparatus 130 shown in FIG. 1, and the third communication apparatus is, for example, the third communication apparatus 110 shown in FIG. 1. The following describes the communication process 200 with reference to FIG. 1.

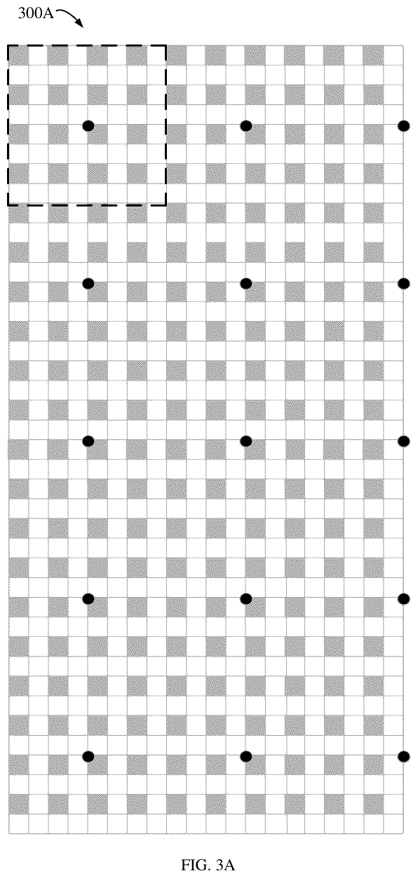

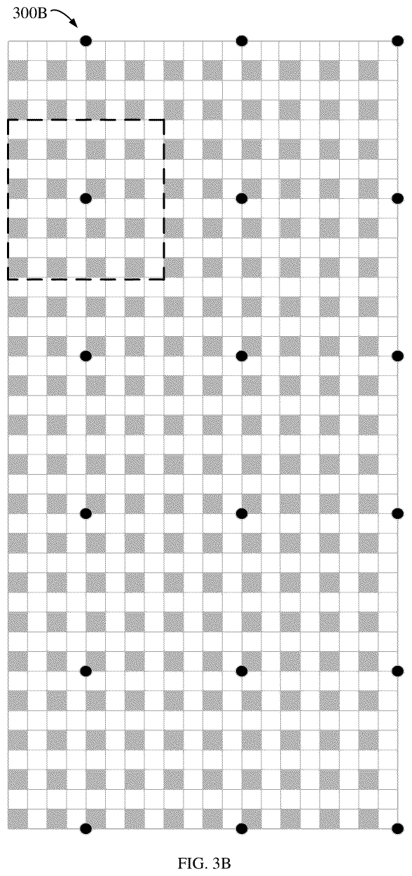

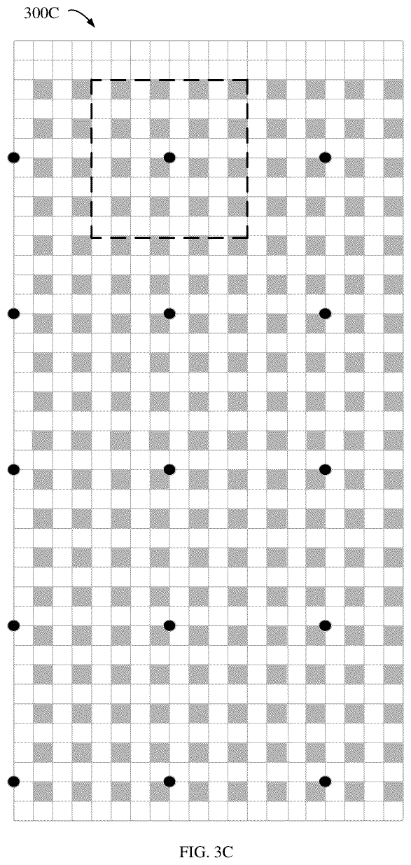

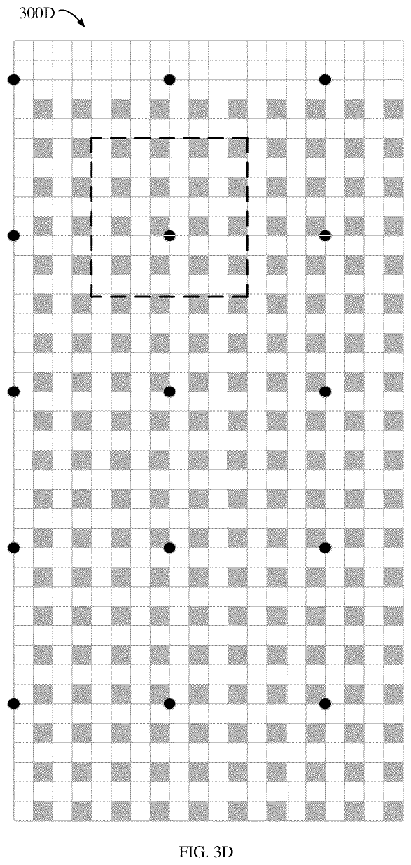

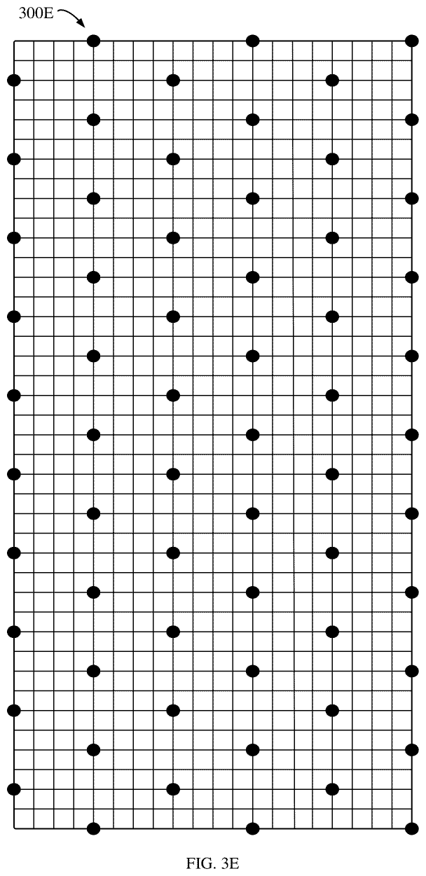

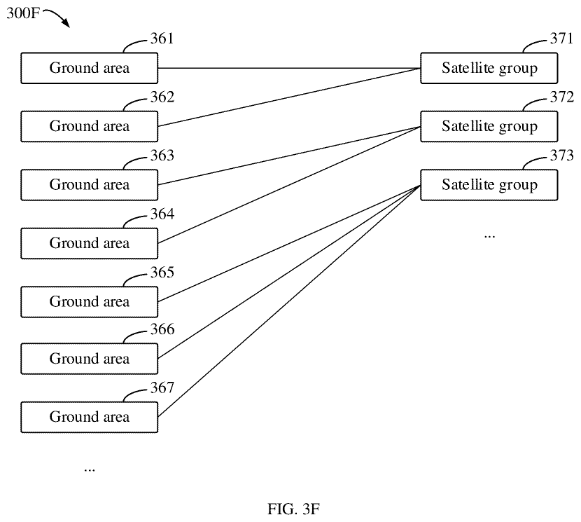

As shown in FIG. 2, in the communication process 200, at 210, the third communication apparatus 110 divides a plurality of satellites into at least one satellite group. For example, the third communication apparatus 110 may divide a plurality of satellites (3,360 satellites in a case of a 5^{th} layer of satellite constellation) included in a layer (for example, a 5^{th} layer) of satellite constellation in the plurality of layers of constellations shown in Table 1 into at least one satellite group. For this, further descriptions are provided later with reference to FIG. 3F and Table 1.

Then, at 220, the third communication apparatus 110 determines at least one ground area unit associated with the at least one satellite group. For this, further descriptions are provided later with reference to FIG. 3A to FIG. 3E.

Then, the third communication apparatus 110 sends (230) configuration information 201 to the second communication apparatus 130, where the configuration information 201 indicates the at least one satellite group obtained in 210 and the at least one ground area unit that is associated with the at least one satellite group and that is determined in 220. Sending (230) the configuration information 201 may be implemented, for example, through broadcast (broadcast). In other words, the third communication apparatus 110 may send (230) the configuration information 201 to all second communication apparatuses 130 managed by the third communication apparatus 110.

The second communication apparatus 130 obtains (232) information indicating the at least one satellite group and the at least one ground area unit associated with the at least one satellite group, for example the configuration information 201. For example, on the other side of communication, the second communication apparatus 130 may receive the configuration information 201 from the third communication apparatus 110. Then, the second communication apparatus 130 performs (250) switching of the first communication apparatus 140 between a plurality of satellites in a satellite group in the at least one satellite group based on the configuration information 201, where the first communication apparatus 140 is in a ground area unit associated with the satellite group.

The second communication apparatus 130 may send, to the first communication apparatus 140, the information indicating the at least one satellite group and the at least one ground area unit associated with the at least one satellite group, for example the configuration information 201. As shown in FIG. 2, the second communication apparatus 130 sends (240) configuration information 202 to the first communication apparatus 140. The configuration information 202 indicates information about the at least one satellite group and the at least one ground area unit associated with the at least one satellite group. A payload of the configuration information 202 may be the same as that of the configuration information 201. Different marks are used herein only to distinguish between the two pieces of configuration information.

On the other side of communication, the first communication apparatus 140 receives (242) the configuration information 202 from the second communication apparatus 130. Then, the first communication apparatus 140 performs (260) switching between the plurality of satellites in the satellite group in the at least one satellite group based on the configuration information 202. Herein, the first communication apparatus 140 is in the ground area unit associated with the satellite group.

It is noted that operations 250 and 260 are shown in FIG. 2, separately, but in actual communication, the two operations are associated and collaborative with each other. For example, the first communication apparatus 140 may perform switching between the plurality of satellites in the satellite group under control of the second communication apparatus 130.

In some embodiments, the first communication apparatus 140 may be or include a terminal device. Alternatively, the first communication apparatus 140 may be or include a chip in the terminal device. In this way, the first communication apparatus 140 can be implemented in a plurality of forms based on requirements in various application scenarios, to implement a function of the first communication apparatus 140.

In some embodiments, to obtain the configuration information 201, the second communication apparatus 130 may receive the configuration information 201 from the third communication apparatus 110. The configuration information 201 indicates the at least one satellite group and the at least one ground area unit associated with the at least one satellite group. In this way, frequent switching in a large constellation can be reduced, and frequencies of inter-group switching and intra-group switching of a satellite group can be decoupled from a scale of satellites before grouping, and are always kept in a low range. In addition, inter-satellite interference can be effectively reduced to effectively increase a ground capacity.

In some embodiments, the switching may be switching between two satellite groups in the at least one satellite group. Additionally or alternatively, the switching may be switching between two satellites in one of the at least one satellite group. In this way, frequent switching in the large constellation can be reduced, and frequencies of inter-group switching and intra-group switching of the satellite group can be decoupled from the scale of the satellites before grouping, and are always kept in the low range. In addition, inter-satellite interference can be effectively reduced to effectively increase the ground capacity.

In some embodiments, the at least one satellite group has different latitudes of coverage areas. For example, more inter-orbit groups are introduced in an orbit in a high-latitude area than an orbit in a low-latitude area. In this way, inter-orbit switching is further reduced in the high-latitude area with a high satellite orbit density.

In some embodiments, the at least one satellite group may include an intra-orbit satellite group and an inter-orbit satellite group, satellites in the intra-orbit satellite group belong to a same orbit, and satellites in the inter-orbit satellite group belong to at least two different orbits. In this way, frequent switching in the large constellation can be reduced. In addition, inter-satellite interference can be effectively reduced to effectively increase the ground capacity.

In some embodiments, altitudes of satellites in a satellite group in the at least one satellite group are approximately the same. For example, a difference between the altitudes of the satellites in the satellite group in the at least one satellite group is lower than a threshold. Additionally or alternatively, inclinations of the satellites in the satellite group in the at least one satellite group are approximately the same. For example, a difference between the inclinations of the satellites in the satellite group in the at least one satellite group is lower than a threshold. Additionally or alternatively, all satellites in the satellite group in the at least one satellite group are in an ascending orbit or a descending orbit. Additionally or alternatively, switching intervals of the satellites in the satellite group in the at least one satellite group are approximately the same. For example, a difference between the switching intervals of the satellites in the satellite group in the at least one satellite group is lower than a threshold. The switching interval is, for example, a difference between time points at which two adjacent satellites in a satellite group sequentially start to provide a communication service for a terminal device (for example, the first terminal apparatus 140 shown in FIG. 1) in a ground area unit associated with the satellite group. For example, the switching interval may be measured by using duration (for example, average duration) for which each satellite in the satellite group provides a communication service for the terminal device in the ground area unit associated with the satellite group. Additionally or alternatively, intra-orbit spacings of the satellites in the satellite group in the at least one satellite group are approximately the same. For example, a difference between the intra-orbit spacings of the satellites in the satellite group in the at least one satellite group is lower than a threshold. Herein, the intra-orbit spacing is a spacing between two adjacent satellites in a same orbit in a same satellite group. Additionally or alternatively, inter-orbit spacings of the satellites in the satellite group in the at least one satellite group are approximately the same. For example, a difference between the inter-orbit spacings of the satellites in the satellite group in the at least one satellite group is lower than a threshold. Herein, the inter-orbit spacing is a spacing between two different orbits in a same satellite group, for example, may be defined as a spacing between respective predefined reference positions of the two orbits. Additionally or alternatively, loads of the satellites in the satellite group in the at least one satellite group are approximately equal. For example, a difference between the loads of the satellites in the satellite group in the at least one satellite group is lower than a threshold. Additionally or alternatively, the satellites in the satellite group in the at least one satellite group are capable of establishing an inter-satellite link. In this way, service stability of grouped satellites in a given area can be ensured, and it can be ensured that there is a short inter-satellite link between a same group of satellites, to ensure switching performance.

In some embodiments, the plurality of satellites may belong to a same large constellation, each of the at least one satellite group has a same quantity of orbits and a same quantity of satellites in each orbit, a quantity of orbits of the large constellation is divisible by the quantity of orbits of each satellite group, and a quantity of satellites in each orbit of the large constellation is divisible by the quantity of satellites in each orbit of each satellite group. In this way, it can be ensured that the satellites in the satellite group have the uniform spacing and the strong switching regularity, it can be ensured that the terminal device (for example, the first communication apparatus 140 shown in FIG. 1) stays for similar time in the ground area unit served by each satellite, and stays for as long as possible in the ground area unit served by each satellite. In addition, regardless of protocol efficiency, switching overheads can be reduced proportionally. Herein, the “protocol efficiency” means, for example, signaling overheads in a switching process specified in a 3GPP protocol.

In some embodiments, the quantity of orbits of the large constellation is M1, and the quantity of satellites in each of the M1 orbits is N1, where M1 and N1 are natural numbers; and a size of each of the at least one satellite group is M2×N2, where M1 mod M2=0, N1 mod N2=0, M2 represents the quantity of orbits of each satellite group, N2 represents the quantity of satellites in each orbit of each satellite group, and mod represents a modulo operation. In this way, it can be ensured that the satellites in the satellite group have the uniform spacing and the strong switching regularity, it can be ensured that the terminal device (for example, the first communication apparatus 140 shown in FIG. 1) stays for similar time in the ground area unit served by each satellite, and stays for as long as possible in the ground area unit served by each satellite. In addition, regardless of protocol efficiency, switching overheads can be reduced proportionally.

In some embodiments, a quantity of the at least one satellite group is (M1×N1)/(M2×N2)×2, where “×2” represents that a satellite in an ascending orbit and a satellite in a descending orbit belong to different satellite groups. In this way, it can be ensured that there may be a short inter-satellite link between a same group of satellites, to ensure switching performance.

In some embodiments, for a satellite group in the at least one satellite group, the third communication apparatus 110 may determine, based on a distance between a reference position of a ground area unit in the at least one ground area unit and an orbit, a correspondence between the ground area unit and the orbit to which a satellite in the satellite group belongs. In addition, for the satellite group in the at least one satellite group, the third communication apparatus 110 may determine a correspondence between the ground area unit and the satellite group based on a distance between the reference position and the satellite group. In this way, for the satellite group in the at least one satellite group, the correspondence between the ground area unit and the orbit to which the satellite in the satellite group belongs is based on the distance between the reference position of the ground area unit in the at least one ground area unit and the orbit. In addition, for the satellite group in the at least one satellite group, a correspondence between the ground area unit and the satellite group is based on a distance between the reference position and the satellite group. In this way, it can be ensured that the satellites in the satellite group have the uniform spacing and the strong switching regularity.

In some embodiments, the third communication apparatus 110 may determine the correspondence between the ground area unit and the orbit based on the distance between the reference position and the orbit being less than or equal to a first distance threshold. Additionally or alternatively, the third communication apparatus 110 may determine the non-correspondence between the ground area unit and the orbit based on the distance between the reference position and the orbit being greater than the first distance threshold. Alternatively, the third communication apparatus 110 may determine the correspondence between the ground area unit and the orbit based on the distance between the reference position and the orbit being less than the first distance threshold. Additionally or alternatively, the third communication apparatus 110 may determine the non-correspondence between the ground area unit and the orbit based on the distance between the reference position and the orbit being greater than or equal to the first distance threshold. In this way, the correspondence between the ground area unit and the orbit is based on the distance between the reference position and the orbit being less than or equal to the first distance threshold. Additionally or alternatively, the non-correspondence between the ground area unit and the orbit is based on the distance between the reference position and the orbit being greater than the first distance threshold. Alternatively, the correspondence between the ground area unit and the orbit is based on the distance between the reference position and the orbit being less than the first distance threshold. Additionally or alternatively, the non-correspondence between the ground area unit and the orbit is based on the distance between the reference position and the orbit being greater than or equal to the first distance threshold. In this way, it can be ensured that the satellites in the satellite group have the uniform spacing and the strong switching regularity.

In some embodiments, the third communication apparatus 110 may determine a correspondence between the ground area unit and the satellite in the satellite group based on a distance between the reference position and the satellite in the satellite group being less than or equal to a second distance threshold, where the satellite in the satellite group provides a communication service for a first communication apparatus in the ground area unit. Additionally or alternatively, the third communication apparatus 110 may determine a non-correspondence between the ground area unit and the satellite in the satellite group based on a distance between the reference position and the satellite in the satellite group being greater than a second distance threshold, where the satellite in the satellite group does not provide a communication service for a first communication apparatus in the ground area unit. Alternatively, the third communication apparatus 110 may determine the correspondence between the ground area unit and the satellite in the satellite group based on the distance between the reference position and the satellite in the satellite group being less than the second distance threshold. Additionally or alternatively, the third communication apparatus 110 may determine the non-correspondence between the ground area unit and the satellite in the satellite group based on the distance between the reference position and the satellite in the satellite group being greater than or equal to the second distance threshold. In this way, the correspondence between the ground area unit and the satellite in the satellite group is based on the distance between the reference position and the satellite in the satellite group being less than or equal to the second distance threshold, where the satellite in the satellite group provides the communication service for the first communication apparatus in the ground area unit. Additionally or alternatively, the non-correspondence between the ground area unit and the satellite in the satellite group is based on the distance between the reference position and the satellite in the satellite group being greater than the second distance threshold, where the satellite in the satellite group does not provide the communication service for the first communication apparatus in the ground area unit. Alternatively, the correspondence between the ground area unit and the satellite in the satellite group is based on the distance between the reference position and the satellite in the satellite group being less than the second distance threshold. Additionally or alternatively, the non-correspondence between the ground area unit and the satellite in the satellite group is based on the distance between the reference position and the satellite in the satellite group being greater than or equal to the second distance threshold. In this way, it can be ensured that the satellites in the satellite group have the uniform spacing and the strong switching regularity.

In some embodiments, the distance between the reference position and the satellite group is a distance between the reference position and a central position of the satellite group, and the reference position is a central point of the ground area unit. In this way, it can be ensured that the satellites in the satellite group have the uniform spacing and the strong switching regularity.

In some embodiments, the configuration information includes a ground area unit served by a satellite in the satellite group in the at least one satellite group. Additionally or alternatively, the configuration information includes a trigger rule for switching of the satellite group. The third communication apparatus 110 may simultaneously send (230) the ground area unit and the trigger rule to the second communication apparatus 130. Alternatively, the third communication apparatus 110 may separately send (230) one of the ground area unit and the trigger rule to the second communication apparatus 130, or the third communication apparatus 110 may send (230) the ground area unit and the trigger rule to the second communication apparatus 130 in sequence. At the second communication apparatus 130, the second communication apparatus 130 may simultaneously send (240) the ground area unit and the trigger rule to the first communication apparatus 140. Alternatively, the second communication apparatus 130 may separately send (240) one of the ground area unit and the trigger rule to the first communication apparatus 140, or the second communication apparatus 130 may send (240) the ground area unit and the trigger rule to the first communication apparatus 140 in sequence. In this way, load balancing of satellites in the group can be ensured through simple configuration, and loads are effectively distributed to the satellites in the group. In other words, it can be ensured that the satellites in the group have the uniform spacing and the strong switching regularity, it can be ensured that the terminal device stays for similar time in the ground area unit served by each satellite, and stays for as long as possible in the ground area unit served by each satellite. In addition, regardless of protocol efficiency, switching overheads can be reduced proportionally.

In some embodiments, the trigger rule includes: a latitude of a position of the first communication apparatus in the ground area unit exceeds a threshold. Additionally or alternatively, the trigger rule includes: The satellite in the satellite group switches between an ascending orbit and a descending orbit relative to a movement trajectory of the first communication apparatus in the ground area unit. Additionally or alternatively, the trigger rule includes: time during which the satellite group provides the communication service for the first communication apparatus in the ground area unit exceeds a threshold. In this way, load balancing of satellites in the group can be ensured, and loads are effectively distributed to the satellites in the group. In other words, it can be ensured that the satellites in the group have the uniform spacing and the strong switching regularity, it can be ensured that the terminal device stays for similar time in the ground area unit served by each satellite, and stays for as long as possible in the ground area unit served by each satellite. In addition, regardless of protocol efficiency, switching overheads can be reduced proportionally.

In some embodiments, the third communication apparatus 110 may determine a ground area unit in the at least one ground area unit, so that a length of the ground area unit in a movement direction of a first satellite in the satellite group in the at least one satellite group is not greater than half of an overlapping area of coverage areas of two adjacent satellites in an orbit to which the first satellite belongs before the first satellite is grouped. In this way, the length of the ground area unit in the at least one ground area unit in the movement direction of the first satellite in the satellite group in the at least one satellite group is not greater than half of the overlapping area of the coverage areas of the two adjacent satellites in the orbit to which the first satellite belongs before the first satellite is grouped. In this way, a proper size of the ground area unit can be set in a satellite movement direction.

In some embodiments, the third communication apparatus 110 may determine a ground area unit in the at least one ground area unit, so that a length of the ground area unit in an earth rotation direction is not greater than half of an overlapping area of coverage areas of two adjacent satellites in an orbit to which a second satellite belongs before the second satellite in the satellite group in the at least one satellite group is grouped. In this way, the length of the ground area unit in the at least one ground area unit in the earth rotation direction is not greater than half of the overlapping area of the coverage areas of the two adjacent satellites in the orbit to which the second satellite belongs before the second satellite in the satellite group in the at least one satellite group is grouped. In this way, a proper size of the ground area unit can be set in the earth rotation direction.

In the following, FIG. 3A to FIG. 3D are diagrams of association between different ground area units on a same ground surface and respective corresponding satellite groups. FIG. 3A is a diagram 300A of a satellite group associated with a ground area unit according to example implementations of some embodiments. A black solid dot represents a satellite. Correspondingly, a set of black solid dots may represent a satellite group. A gray solid square represents an area served by a corresponding satellite on the ground (sometimes also referred to as a “ground area unit”). For example, the gray solid square may represent an area, on the ground, served by a satellite represented by the black solid dot. A dashed box represents a maximum range of a beam transmitted by a satellite in the box for sweeping the ground area unit. For example, the range may be represented by a latitude.

FIG. 3B is a diagram 300B of a satellite group associated with a ground area unit according to example implementations of some embodiments. A black solid dot represents a satellite. Correspondingly, a set of black solid dots may represent a satellite group. A gray solid square represents an area served by a corresponding satellite on the ground (for example a “ground area unit”). The gray solid square may represent an area, on the ground, served by a satellite represented by the black solid dot. A dashed box represents a maximum range of a beam transmitted by a satellite in the box for sweeping the ground area unit. For example, the range may be represented by a latitude.

FIG. 3C is a diagram 300C of a satellite group associated with a ground area unit according to example implementations of some embodiments. A black solid dot represents a satellite. Correspondingly, a set of black solid dots may represent a satellite group. A gray solid square represents an area served by a corresponding satellite on the ground (for example a “ground area unit”). The gray solid square may represent an area, on the ground, served by a satellite represented by the black solid dot. A dashed box represents a maximum range of a beam transmitted by a satellite in the box for sweeping the ground area unit. For example, the range may be represented by a latitude.

FIG. 3D is a diagram 300D of a satellite group associated with a ground area unit according to example implementations of some embodiments. A black solid dot represents a satellite. Correspondingly, a set of black solid dots may represent a satellite group. A gray solid square represents an area served by a corresponding satellite on the ground (for example a “ground area unit”). The gray solid square may represent an area, on the ground, served by a satellite represented by the black solid dot. A dashed box represents a maximum range of a beam transmitted by a satellite in the box for sweeping the ground area unit. For example, the range may be represented by a latitude.

FIG. 3E is a diagram of a satellite group 300E associated with a ground area unit according to example implementations of some embodiments. The diagram is superposition of the satellite groups 300A, 300B, 300C, and 300D on the ground surface shown in FIG. 3A to FIG. 3D. The satellite group 300E is a set of the satellite groups 300A, 300B, 300C, and 300D.

FIG. 3F is a diagram 300F of association between a ground area unit and a satellite group according to example implementations of some embodiments. As shown in FIG. 3F, a ground area unit 361 is associated with a satellite group 371, for example a satellite in the satellite group 371 provides a network connection service (also referred to as a “communication service”) for the ground area unit 361 (for example a terminal device in the ground area unit 361). A ground area unit 362 is also associated with the satellite group 371. Both a ground area unit 363 and a ground area unit 364 are associated with a satellite group 372. A ground area unit 365, a ground area unit 366, and a ground area unit 367 are all associated with a satellite group 373. In the embodiment shown in FIG. 3F, one ground area unit is associated with only one satellite group, but one satellite group may be associated with a plurality of ground area units.

In this way, a quantity of groups in a large constellation that can be divided is determined based on a visible orbit of a given position/area and a quantity of satellites in an orbit, to ensure that each small constellation can provide continuous coverage in the area after grouping. Each given position/area/UE is associated with a satellite group and communicates with satellites in a same satellite group by default. Optionally, a UE (for example, the first communication apparatus 140 shown in FIG. 1A) may be notified of a grouping configuration message of a network-side satellite. For example, the UE may be notified of the grouping configuration message via a base station (for example, the second communication apparatus 130 shown in FIG. 1A).

There may be a transparent mode and a regenerative mode based on an operating mode of a satellite device. When the satellite operates in the transparent mode, the satellite has a relay forwarding function. A gateway has functions of a base station or some functions of the base station. In this case, the gateway may be considered as a base station. Alternatively, the base station and the gateway may be separately deployed. In this case, a feeder link delay includes two parts: a delay from the satellite to the gateway and a delay from the gateway to a gNB. A case in which the gateway and the gNB are located together or close to each other is used as an example in the transparent mode discussed below. When the gateway is far away from the gNB, the delay from the satellite to the gateway and the delay from the gateway to the gNB are added to obtain a feeder link delay.

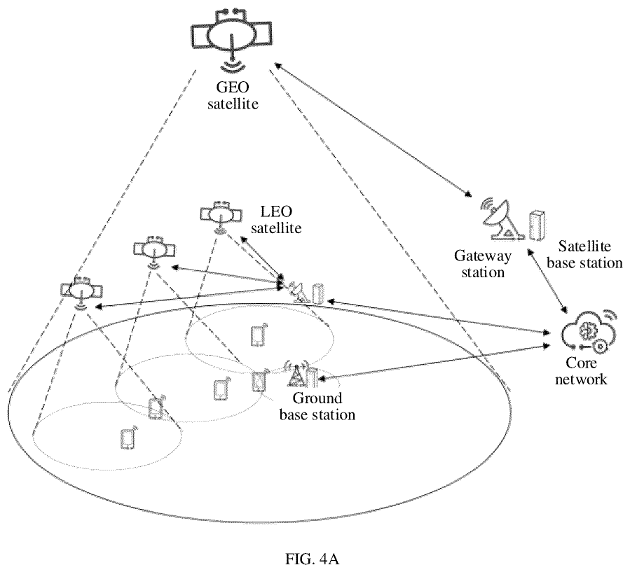

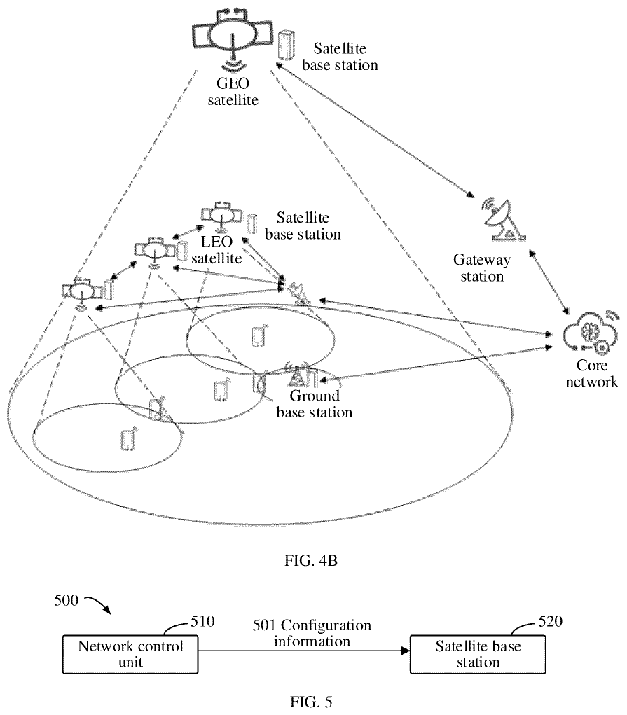

FIG. 4A is a diagram of a converged network architecture 400A in a transparent mode according to example implementations of some embodiments. The converged network architecture 400A may be considered as an implementation of the communication system 100B depicted in FIG. 1B. The following describes the converged network architecture 400A by using an example with reference to FIG. 1B.

As shown in FIG. 4A, an NTN component is of a transparent architecture. For example, a base station (a “satellite base station” shown in FIG. 4A, for example, may correspond to the second communication apparatus 130 shown in FIG. 1) entity is on the ground. In the embodiment shown in FIG. 4A, a satellite may be replaced with another non-ground load such as a HAPS. An

NTN and a base station of a terrestrial network may be interconnected by using a common core network. Alternatively, assistance and interconnection with higher timeliness may be implemented through an interface defined between base stations. In NR, an interface between base stations is referred to as an Xn interface, and an interface between a base station and a core network is referred to as an NG interface. In a converged network, an NTN node and a ground node implement interworking and collaboration through the foregoing interfaces.

Network devices in the satellite communication scenario shown in FIG. 4A include a satellite device and a gateway device. A user terminal includes an internet of things terminal device, or may be a terminal device in another form and performance, for example, a mobile terminal or a high-altitude aircraft. This is not limited herein. A link between a satellite and a user terminal is referred to as a service link and a link between a satellite and a gateway is referred to as a feeder link.

FIG. 4B is a diagram of a converged network architecture 400B in a regenerative mode according to example implementations of some embodiments. The converged network architecture 400B may be considered as an implementation of the communication system 100C depicted in FIG. 1C. The following describes the converged network architecture 400B by using an example with reference to FIG. 1C.

As shown in FIG. 4B, when a satellite operates in a regenerative mode, because the satellite has a data processing capability and has some functions of a base station, the satellite may be considered as a base station (a “satellite base station” shown in FIG. 4B) in this case.

Similar to the embodiment shown in FIG. 4A, in the embodiment shown in FIG. 4B, the satellite may also be replaced with another non-ground load such as a HAPS. An NTN and a base station of a terrestrial network may also be interconnected by using a common core network. Alternatively, assistance and interconnection with higher timeliness may be implemented through an interface defined between base stations. In NR, an interface between base stations is referred to as an Xn interface, and an interface between a base station and a core network is referred to as an NG interface. In a converged network, an NTN node and a ground node may implement interworking and collaboration through the foregoing interfaces.

Similar to the embodiment shown in FIG. 4A, network devices in the satellite communication scenario shown in FIG. 4B include a satellite device and a gateway device. A user terminal includes an internet of things terminal device, or may be a terminal device in another form and performance, for example, a mobile terminal or a high-altitude aircraft. This is not limited herein.

A satellite group changes with a coverage area (such as a latitude) of a satellite beam, an ascending orbit/descending orbit status, and time. A network control unit should notify a satellite grouping status. This is described below with reference to FIG. 5.

FIG. 5 is a flowchart of a communication process 500 according to some embodiments. In a possible implementation, the communication process 500 relates to a network control unit 510 (for example, the third communication apparatus 110 in the communication system 100A shown in FIG. 1) and a satellite base station (for example, the second communication apparatus 120 in the communication system 100A shown in FIG. 1), for example, may be implemented by the third communication apparatus 110 in the communication system 100A. The network control unit 510 may be, for example, a beam position controller or include a beam position controller. Alternatively, the communication process 500 may be implemented by a UE or a gNB/eNB including a beam position controller. In another possible implementation, the communication process 500 may alternatively be implemented by another electronic apparatus independent of the communication system 100A. In an example, the communication process 500 is described below by using an example in which the communication process 500 is implemented by the network control unit 510 (for example, the third communication apparatus 110 in the communication system 100A shown in FIG. 1).

As shown in FIG. 5, the network control unit 510 sends configuration information 501 of a satellite group to the satellite base station 520 (for example, the second communication apparatus 120 in the communication system 100A shown in FIG. 1). For example, the configuration information 501 may be or include the configuration information 201 shown in FIG. 2, and indicates at least one satellite group and at least one ground area unit associated with the at least one satellite group, and notify the satellite base station 120 of a ground area unit associated with the satellite group. For example, the configuration information 501 may include ground area units that need to be swept by different satellite groups. Alternatively or additionally, the configuration information 501 may further include a trigger rule for change of the satellite group. The trigger rule may be that a latitude of a satellite reaches a threshold, switching between an ascending orbit and a descending orbit of a satellite, or that time during which a satellite group provides a communication service for a UE in a ground area unit exceeds a threshold.

For example, a satellite grouping policy should be able to ensure that a link between grouped satellites (sometimes also referred to as an “inter-satellite link” briefly) is stable, and service duration of each satellite for a UE (for example, the first communication apparatus 140 shown in FIG. 1A) in a ground area unit associated with the satellite is as similar as possible. For example, when the satellite grouping policy is formulated, switching reliability of a serving satellite needs to be considered, so that a good inter-satellite communication capability is needed between satellites in a same group, it is difficult to establish an inter-satellite link between satellites with different altitudes and different inclinations, and it is difficult to establish an inter-satellite link between a satellite in an ascending orbit and a satellite in a descending orbit. Uniform switching intervals of the grouped satellites further need to be considered, so that loads of the satellites are balanced. In addition, a distance between orbits in a high-latitude area becomes shorter. Therefore, it is considered that more inter-orbit groups are introduced compared to a low-latitude area to further reduce inter-orbit switching.

In an embodiment, for example, satellites at a same layer (with a same altitude and a same inclination) belong to a group, and satellites with different orbital altitudes/different inclinations belong to different groups; ascending orbits or descending orbits of satellites at a same layer belongs to a group, and ascending orbits and descending orbits with a same orbital altitude belong to different groups. In addition, after the satellites at the same layer are grouped, a quantity of orbits and a quantity of satellites in an orbit in each satellite group is divisible by a quantity of orbits and a quantity of satellites in the orbit in a constellation before grouping. A quantity of satellite groups is determined based on different latitudes, and quantities of satellite groups at different latitudes are different.

A 5^{th} layer of satellite constellation in parameters of a plurality of layers of LEO satellite constellations shown in Table 1 is used as an example. As shown in Table 2, the 5^{th} layer of satellite constellation in Table 1 has 28 orbits with an altitude of 525 km, an inclination of 53°, and 120 satellites in each orbit. Therefore, there are 3,360 (=28×120) satellites in total in the 5^{th} layer of satellite constellation.

TABLE 2

| | | | | |
|---|---|---|---|---|
| 525 | 53 | 28 | 120 | 3,360 |

In some embodiments, the 5^{th} layer of satellite constellation is divided into two groups for inter-orbit, four groups for intra-orbit, and two groups for ascending orbit and descending orbit in equatorial and mid-latitude areas. The satellite constellation may be divided into a total of 2×2×4=16 groups, as shown in Table 3.

After grouping, each group is a subset of an original large constellation, and may be considered as a small satellite constellation (referred to as a “small constellation” briefly). Therefore, it may also be described that the quantity of orbits and the quantity of satellites in the orbit in each satellite group (“small constellation”) after the satellites at the same layer (“large constellation”) are grouped is divisible by the quantity of orbits and the quantity of satellites in the orbit in the constellation before grouping (for example “large constellation”).

TABLE 3

| | | | | | Ascending | Satellite | Satellite sequence |
|---|---|---|---|---|---|---|---|
| | | | Quantity of | | orbit/ | group orbit | number in a |
| | | Orbital | satellites per | Group | Descending | sequence | satellite group |
| Altitude | Inclination | plane | orbital plane | number | orbit | number | orbital plane |
| 525 | 53 | 28 | 120 | 1 | Ascending | 1:2:28 | 1:4:120 |
| | | | | 2 | orbit | 1:2:28 | 2:4:120 |
| | | | | 3 | | 1:2:28 | 3:4:120 |
| | | | | 4 | | 1:2:28 | 4:4:120 |
| | | | | 5 | | 2:2:28 | 1:4:120 |
| | | | | 6 | | 2:2:28 | 2:4:120 |
| | | | | 7 | | 2:2:28 | 3:4:120 |
| | | | | 8 | | 2:2:28 | 4:4:120 |
| | | | | 9 | Descending | 1:2:28 | 1:4:120 |
| | | | | 10 | orbit | 1:2:28 | 2:4:120 |
| | | | | 11 | | 1:2:28 | 3:4:120 |
| | | | | 12 | | 1:2:28 | 4:4:120 |
| | | | | 13 | | 2:2:28 | 1:4:120 |
| | | | | 14 | | 2:2:28 | 2:4:120 |
| | | | | 15 | | 2:2:28 | 3:4:120 |
| | | | | 16 | | 2:2:28 | 4:4:120 |

As shown in Table 3, in the parameters of the plurality of layers of LEO constellations shown in FIG. 1C, the 5^{th} layer of constellation (which may be considered as the “large constellation”) is divided into 16 groups, and is divided into two groups for inter-orbit, four groups for intra-orbit, and two groups for ascending orbit and descending orbit in the equatorial and mid-latitude areas as described above. An orbit sequence number of a 1^{st} satellite group (for example a satellite group whose group number is 1) is 1:2:28, where “1:2:28” indicates that a sequence number increases from 1 at an interval of 2 until a sequence number 28 (28 is a quantity of orbital planes in the large constellation), and there are 14 orbit sequence numbers in total, for example a quantity of orbits of the 1^{st} satellite group (which may also be referred to as a “1^{st} small constellation”) is 14. In addition, a satellite sequence number in an orbital plane of the 1^{st} satellite group is “1:4:120”, where “1:4:120” indicates that a sequence number increases from 1 at an interval of 4 until a sequence number 120 (120 is a quantity of satellites per orbital plane in the large constellation), and there are 30 satellites in total, for example a quantity of satellites per orbital plane in the 1^{st} satellite group is 30. Thus, the 1^{st} satellite group has 14 orbits, and each orbit has 30 satellites. Therefore, the 1^{st} satellite group includes 420 (=14×30) satellites.

For a 9^{th} satellite group (for example a satellite group whose group number is 9), although a satellite group orbit sequence number and a satellite sequence number in a satellite group orbital plane are the same as those of the 1^{st} satellite group, because the 1^{st} satellite group belongs to the ascending orbit and the 9^{th} satellite group belongs to the descending orbit, the 9^{th} satellite group is a satellite group different from the 1^{st} satellite group. Composition of a 2^{nd} satellite group to an 8^{th} satellite group is similar to that of the 1^{st} satellite group, and composition of a 10^{th} satellite group to a 16^{th} satellite group is similar to that of the 9^{th} satellite group. Details are not described herein again.

As described above, the distance between the orbits in the high-latitude area becomes shorter. Therefore, more inter-orbit groups are introduced compared to the low-latitude area to further reduce inter-orbit switching. For example, in some embodiments, the 5^{th} layer of satellite constellation is divided into four groups for inter-orbit, four groups for intra-orbit, and two groups for ascending orbit and descending orbit in the high-latitude area. In this case, the satellite constellation may be divided into a total of 4×2×4=32 groups.

Two aspects may be considered when a discrete granularity of a ground area unit is designed or planned. In one aspect, if the discrete granularity of the ground area unit is small, it is helpful to prolong time during which the ground area unit accepts a communication service provided by a satellite group, and to balance load and resource management between satellite groups. However, if the discrete granularity of the ground area unit is excessively small, the ground area unit is excessively small, and frequent switching between the ground area units is caused by movement of the UE. In addition, a proportion of overlapping areas of coverage areas of different satellites is very high, and inter-satellite coordination dependency is increased during intra-frequency networking. In another aspect, if the discrete granularity of the ground area unit is large, an overlapping phenomenon of coverage areas of different satellites may be reduced. However, if the discrete granularity of the ground area unit is excessively large, time for providing a communication service by a satellite in a satellite group associated with the ground area unit may be excessively short.

Therefore, in some embodiments, the network control unit (for example, the third communication apparatus 110 shown in FIG. 1 or the network control unit 510 shown in FIG. 5) divides a ground surface into a plurality of ground area units in a direction perpendicular to an orbit to which the satellite in the satellite group belongs, so that a length of each of the plurality of ground area units in a movement direction of the satellite is not greater than half of an overlapping area of coverage areas of two adjacent satellites in an orbit to which the satellite belongs before the satellite is grouped. In this way, a proper size of the ground area unit can be set in a satellite movement direction.

Additionally or alternatively, the network control unit may divide a ground surface into a plurality of ground area units in a direction perpendicular to an earth rotation direction, so that a length of each of the plurality of ground area units in the earth rotation direction is not greater than half of an overlapping area of coverage areas of two adjacent satellites in an orbit to which the satellite belongs before the satellite is grouped. In this way, a proper size of the ground area unit can be set in the earth rotation direction.

The foregoing describes a case in which the third communication apparatus 110 is separated from the second communication apparatus 130. In this case, to obtain information indicating at least one satellite group and at least one ground area unit associated with the at least one satellite group, the second communication apparatus 130 may receive configuration information from the third communication apparatus 110, where the configuration information indicates the at least one satellite group and the at least one ground area unit associated with the at least one satellite group. The processing procedure is shown in FIG. 2. For example, as shown in FIG. 2, the third communication apparatus 110 sends (230) configuration information 201 to the second communication apparatus 130, where the configuration information 201 indicates the at least one satellite group obtained in 210 and the at least one ground area unit that is associated with the at least one satellite group and that is determined in 220. In addition, on the other side of communication, the second communication apparatus 130 receives the configuration information 201 from the third communication apparatus 110.

It should be noted that functions of the third communication apparatus 110 may alternatively be partially implemented in the second communication apparatus 130. In this case, the second communication apparatus 130 may determine (obtain) the information (equivalent to the configuration information 201 shown in FIG. 2, and a difference lies only in that the configuration information herein is determined by the second communication apparatus 130 instead of being received from the third communication apparatus 110) indicating the at least one satellite group and the at least one ground area unit associated with the at least one satellite group based on, for example, information fed back by the terminal device (for example, the first communication apparatus 140 shown in FIG. 1), and then perform subsequent processing based on the information.

In the foregoing manner, dividing the plurality of satellites into the plurality of satellite groups can effectively reduce a switching frequency of a satellite. This is described through simulation. In simulation, a large satellite constellation with an altitude of 550 km, an inclination of 55°, 60 orbital planes, and 60 satellites per orbital plane is selected for use. A maximum switching time interval of a small-scale constellation at the orbital altitude that meets global coverage is about 6 minutes. The ground is uniformly discretized and then associated with satellite groups. Simulation data is shown in Table 4.

As shown in Table 4, the foregoing large satellite constellation is not grouped in a 1^{st} row of data, and a classic RSRP-based method (for example the “optimal satellite RSRP” association algorithm shown in Table 4) is used to associate a UE and a satellite. A switching frequency is 1.059, and corresponds to switching once at an interval of 1 minute. The foregoing large satellite constellation is not grouped in a 3rd row of data, and two classic RSRP-based methods (for example the “optimal satellite RSRP+optimal intra-orbit satellite RSRP” association algorithm shown in Table 4) are used to associate a UE and a satellite. A switching frequency is 0.638, and corresponds to switching once at an interval of 1.6 minutes.

In a 2^{nd} row of data, the foregoing large satellite constellation is first grouped, and then a classic RSRP-based method (for example the “optimal satellite RSRP” association algorithm shown in Table 4) is used to associate a UE and a satellite. A switching frequency is 0.404, and corresponds to switching once at an interval of 2.5 minutes. Compared with the 1^{st} row of data (the case in which the foregoing large satellite constellation is not grouped), a quantity of times of switching is reduced from 8,639 to 3,298, a decrease of 61.8%. A quantity of times of same-orbit switching is reduced from 1254 to 0, a decrease of 100%. In addition, as described above, the 1^{st} row of data corresponds to switching once at the interval of 1 minute, and the 3rd row of data corresponds to switching once at the interval of 2.5 minutes, a decrease of the switching frequency by 60%.

Similarly, in a 4^{th} row of data, the foregoing large satellite constellation is first grouped, and then two classic RSRP-based methods (for example the “optimal satellite RSRP+optimal intra-orbit satellite RSRP” association algorithm shown in Table 4) are used to associate a UE and a satellite. A switching frequency is 0.167, and corresponds to switching once at an interval of 6 minutes. Compared with the 3rd row of data (the case in which the foregoing large satellite constellation is not grouped), a quantity of times of switching is reduced from 5207 to 1366, a decrease of 73.8%. A quantity of times of same-orbit switching is reduced from 4867 to 1215, a decrease of 75%. In addition, as described above, the 3rd row of data corresponds to switching once at the interval of 1.6 minutes, and the 4^{th} row of data corresponds to switching once at the interval of 6 minutes, a decrease of the switching frequency by 73.8%.

For the satellite group and the ground area unit, the switching frequency can be decoupled from the satellite scale, and is always kept in a low range.

TABLE 4

| | | | | | | | | | Quantity |
|---|---|---|---|---|---|---|---|---|---|
| | | Satellite | | | | | | | of times of |
| Beam | Quantity | beam | | | | | Quantity | | switching |
| position | of beam | position | | Update | | Quantity | of times of | Same-orbit | per minute |
| resolution | positions | grouping | Association | interval | Quantity | of times of | same-orbit | switching | at each beam |
| level | in China | manner | algorithm | (s) | of updates | switching | switching | ratio | position |
| 3 | 816 | One group | Optimal | 5 | 120 | 8639 | 1254 | 14.52% | 1.059 |
| | | | satellite | | | | | | |
| | | | RSRP | | | | | | |
| 3 | 816 | Eight groups | Optimal | 5 | 120 | 3298 | 0 | 0% | 0.404 |
| | | (two layers | satellite | | | | | | |
| | | for inter- | RSRP | | | | | | |
| | | orbit and | | | | | | | |
| | | four layers | | | | | | | |
| | | for intra- | | | | | | | |
| | | orbit) | | | | | | | |
| 3 | 816 | One group | Optimal | 5 | 120 | 5207 | 4867 | 93.47% | 0.638 |
| | | | orbit RSRP + | | | | | | |
| | | | optimal | | | | | | |
| | | | intra-orbit | | | | | | |
| | | | satellite | | | | | | |
| | | | RSRP | | | | | | |
| 3 | 816 | Eight groups | Optimal | 5 | 120 | 1366 | 1215 | 88.95% | 0.167 |
| | | (two layers | orbit RSRP + | | | | | | |
| | | for inter- | optimal | | | | | | |
| | | orbit and | intra-orbit | | | | | | |
| | | four layers | satellite | | | | | | |
| | | for intra- | RSRP | | | | | | |
| | | orbit) | | | | | | | |

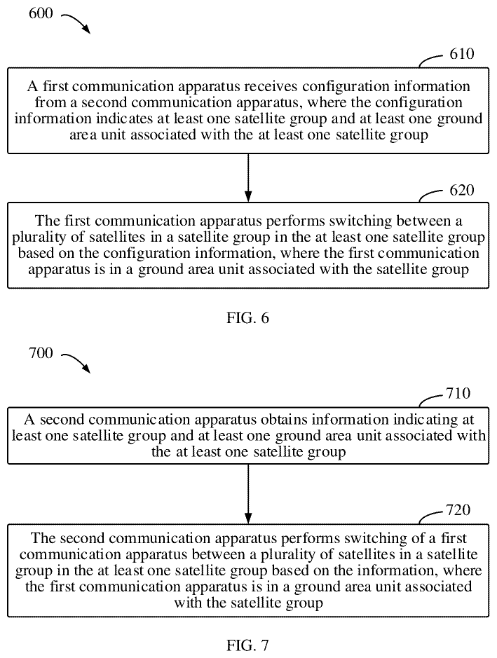

FIG. 6 is a flowchart of a method 600 implemented at a first communication apparatus according to some embodiments. In a possible implementation, the method 600 may be implemented by the first communication apparatus 140 in the communication system 100A shown in FIG. 1. In another possible implementation, the method 600 may alternatively be implemented by another electronic apparatus independent of the communication system 100A. In an example, the method 600 is described below by using an example in which the method 600 is implemented by the first communication apparatus 140 in the communication system 100A.

At 610, the first communication apparatus 140 receives configuration information (for example, the configuration information 202 shown in FIG. 2) from a second communication apparatus 130, where the configuration information indicates at least one satellite group and at least one ground area unit associated with the at least one satellite group. At 620, the first communication apparatus 140 performs switching between a plurality of satellites in a satellite group in the at least one satellite group based on the configuration information, where the first communication apparatus 140 is in a ground area unit associated with the satellite group. In this way, frequent switching in a large constellation can be reduced, and frequencies of inter-group switching and intra-group switching of a satellite group can be decoupled from a scale of satellites before grouping, and are always kept in a low range. In addition, inter-satellite interference can be effectively reduced to effectively increase a ground capacity.

In some embodiments, the first communication apparatus 140 may be or include a terminal device. Alternatively, the first communication apparatus 140 may be or include a chip in the terminal device. In this way, the first communication apparatus 140 can be implemented in a plurality of forms based on requirements in various application scenarios, to implement a function of the first communication apparatus 140.

In some embodiments, the at least one satellite group has different latitudes of coverage areas. For example, more inter-orbit groups are introduced in an orbit in a high-latitude area than an orbit in a low-latitude area. In this way, inter-orbit switching is further reduced in the high-latitude area with a high satellite orbit density.

In some embodiments, the at least one satellite group may include an intra-orbit satellite group and an inter-orbit satellite group, satellites in the intra-orbit satellite group belong to a same orbit, and satellites in the inter-orbit satellite group belong to at least two different orbits. In this way, frequent switching in the large constellation can be reduced. In addition, inter-satellite interference can be effectively reduced to effectively increase the ground capacity.

In some embodiments, altitudes of satellites in a satellite group in the at least one satellite group are approximately the same. For example, a difference between the altitudes of the satellites in the satellite group in the at least one satellite group is lower than a threshold. Additionally or alternatively, inclinations of the satellites in the satellite group in the at least one satellite group are approximately the same. For example, a difference between the inclinations of the satellites in the satellite group in the at least one satellite group is lower than a threshold. Additionally or alternatively, all satellites in the satellite group in the at least one satellite group are in an ascending orbit or a descending orbit. Additionally or alternatively, switching intervals of the satellites in the satellite group in the at least one satellite group are approximately the same. For example, a difference between the switching intervals of the satellites in the satellite group in the at least one satellite group is lower than a threshold. Additionally or alternatively, intra-orbit spacings of the satellites in the satellite group in the at least one satellite group are approximately the same. For example, a difference between the intra-orbit spacings of the satellites in the satellite group in the at least one satellite group is lower than a threshold. Additionally or alternatively, inter-orbit spacings of the satellites in the satellite group in the at least one satellite group are approximately the same. For example, a difference between the inter-orbit spacings of the satellites in the satellite group in the at least one satellite group is lower than a threshold. Additionally or alternatively, loads of the satellites in the satellite group in the at least one satellite group are approximately equal. For example, a difference between the loads of the satellites in the satellite group in the at least one satellite group is lower than a threshold. Additionally or alternatively, the satellites in the satellite group in the at least one satellite group are capable of establishing an inter-satellite link. In this way, service stability of grouped satellites in a given area can be ensured, and it can be ensured that there is a short inter-satellite link between a same group of satellites, to ensure switching performance.

In some embodiments, the plurality of satellites may belong to a same large constellation, each of the at least one satellite group has a same quantity of orbits and a same quantity of satellites in each orbit, a quantity of orbits of the large constellation is divisible by the quantity of orbits of each satellite group, and a quantity of satellites in each orbit of the large constellation is divisible by the quantity of satellites in each orbit of each satellite group. In this way, it can be ensured that the satellites in the satellite group have the uniform spacing and the strong switching regularity, it can be ensured that the terminal device stays for similar time in the ground area unit served by each satellite, and stays for as long as possible in the ground area unit served by each satellite. In addition, regardless of protocol efficiency, switching overheads can be reduced proportionally.

In some embodiments, the quantity of orbits of the large constellation is M1, and the quantity of satellites in each of the M1 orbits is N1, where M1 and N1 are natural numbers; and a size of each of the at least one satellite group is M2×N2, where M1 mod M2=0, N1 mod N2=0, M2 represents the quantity of orbits of each satellite group, N2 represents the quantity of satellites in each orbit of each satellite group, and mod represents a modulo operation. In this way, it can be ensured that the satellites in the group have the uniform spacing and the strong switching regularity, it can be ensured that the terminal device stays for similar time in the ground area unit served by each satellite, and stays for as long as possible in the ground area unit served by each satellite. In addition, regardless of protocol efficiency, switching overheads can be reduced proportionally.

In some embodiments, a quantity of the at least one satellite group is (M1×N1)/(M2×N2)×2, where “×2” represents that a satellite in an ascending orbit and a satellite in a descending orbit belong to different satellite groups. In this way, it can be ensured that there may be a short inter-satellite link between a same group of satellites, to ensure switching performance.

In some embodiments, for a satellite group in the at least one satellite group, a correspondence between the ground area unit and an orbit to which a satellite in the satellite group belongs is based on a distance between a reference position of a ground area unit in the at least one ground area unit and the orbit. In addition, for the satellite group in the at least one satellite group, a correspondence between the ground area unit and the satellite group is based on a distance between the reference position and the satellite group. In this way, it can be ensured that the satellites in the satellite group have the uniform spacing and the strong switching regularity.

In some embodiments, a correspondence between the ground area unit and the orbit is based on a distance between the reference position and the orbit being less than or equal to a first distance threshold. Additionally or alternatively, a non-correspondence between the ground area unit and the orbit is based on a distance between the reference position and the orbit being greater than a first distance threshold. Alternatively, the correspondence between the ground area unit and the orbit is based on the distance between the reference position and the orbit being less than the first distance threshold. Additionally or alternatively, the non-correspondence between the ground area unit and the orbit is based on the distance between the reference position and the orbit being greater than or equal to the first distance threshold. In this way, it can be ensured that the satellites in the satellite group have the uniform spacing and the strong switching regularity.

In some embodiments, a correspondence between the ground area unit and the satellite in the satellite group is based on a distance between the reference position and the satellite in the satellite group being less than or equal to a second distance threshold, where the satellite in the satellite group provides a communication service for a first communication apparatus in the ground area unit. Additionally or alternatively, a non-correspondence between the ground area unit and the satellite in the satellite group is based on a distance between the reference position and the satellite in the satellite group being greater than a second distance threshold, where the satellite in the satellite group does not provide a communication service for a first communication apparatus in the ground area unit. Alternatively, the correspondence between the ground area unit and the satellite in the satellite group is based on the distance between the reference position and the satellite in the satellite group being less than the second distance threshold. Additionally or alternatively, the non-correspondence between the ground area unit and the satellite in the satellite group is based on the distance between the reference position and the satellite in the satellite group being greater than or equal to the second distance threshold. In this way, it can be ensured that the satellites in the satellite group have the uniform spacing and the strong switching regularity.

In some embodiments, the distance between the reference position and the satellite group is a distance between the reference position and a central position of the satellite group, and the reference position is a central point of the ground area unit. In this way, it can be ensured that the satellites in the satellite group have the uniform spacing and the strong switching regularity.

In some embodiments, the configuration information includes a ground area unit served by a satellite in the satellite group in the at least one satellite group. Additionally or alternatively, the configuration information includes a trigger rule for switching of the satellite group. In this way, load balancing of satellites in the group can be ensured through simple configuration, and loads are effectively distributed to the satellites in the group. In other words, it can be ensured that the satellites in the group have the uniform spacing and the strong switching regularity, it can be ensured that the terminal device stays for similar time in the ground area unit served by each satellite, and stays for as long as possible in the ground area unit served by each satellite. In addition, regardless of protocol efficiency, switching overheads can be reduced proportionally.

In some embodiments, the trigger rule includes: a latitude of a position of the first communication apparatus in the ground area unit exceeds a threshold. Additionally or alternatively, the trigger rule includes: the satellite in the satellite group switches between an ascending orbit and a descending orbit relative to a movement trajectory of the first communication apparatus in the ground area unit. Additionally or alternatively, the trigger rule includes: time during which the satellite group provides the communication service for the first communication apparatus in the ground area unit exceeds a threshold. In this way, load balancing of satellites in the group can be ensured, and loads are effectively distributed to the satellites in the group. In other words, it can be ensured that the satellites in the group have the uniform spacing and the strong switching regularity, it can be ensured that the terminal device stays for similar time in the ground area unit served by each satellite, and stays for as long as possible in the ground area unit served by each satellite. In addition, regardless of protocol efficiency, switching overheads can be reduced proportionally.

In some embodiments, a length of the ground area unit in the at least one ground area unit in a movement direction of a first satellite in the satellite group in the at least one satellite group is not greater than half of an overlapping area of coverage areas of two adjacent satellites in an orbit to which the first satellite belongs before the first satellite is grouped. In this way, a proper size of the ground area unit can be set in a satellite movement direction.

In some embodiments, a length of the ground area unit in the at least one ground area unit in an earth rotation direction is not greater than half of an overlapping area of coverage areas of two adjacent satellites in an orbit to which a second satellite belongs before the second satellite in the satellite group in the at least one satellite group is grouped. In this way, a proper size of the ground area unit can be set in the earth rotation direction.

FIG. 7 is a flowchart of a method 700 implemented at a second communication apparatus according to some embodiments. In a possible implementation, the method 700 may be implemented by the second communication apparatus 130 in the communication system 100A shown in FIG. 1 or the satellite base station 520 shown in FIG. 5. In another possible implementation, the method 700 may alternatively be implemented by another electronic apparatus independent of the communication system 100A. In an example, the method 700 is described below by using an example in which the method 700 is implemented by the second communication apparatus 130 in the communication system 100A.

At 710, the second communication apparatus 130 obtains information indicating at least one satellite group and at least one ground area unit associated with the at least one satellite group, where the information may be, for example, the configuration information 201 shown in FIG. 2. At 720, the second communication apparatus 130 performs switching of a first communication apparatus between a plurality of satellites in a satellite group in the at least one satellite group based on the information, where the first communication apparatus 140 is in a ground area unit associated with the satellite group. In this way, frequent switching in a large constellation can be reduced, and frequencies of inter-group switching and intra-group switching of a satellite group can be decoupled from a scale of satellites before grouping, and are always kept in a low range. In addition, inter-satellite interference can be effectively reduced to effectively increase a ground capacity.

In some embodiments, to obtain the information, the second communication apparatus 130 may receive configuration information (for example, the configuration information 201 shown in FIG. 2) from a third communication apparatus 110. The configuration information indicates the at least one satellite group and the at least one ground area unit associated with the at least one satellite group. In this way, frequent switching in the large constellation can be reduced, and frequencies of inter-group switching and intra-group switching of the satellite group can be decoupled from the scale of the satellites before grouping, and are always kept in the low range. In addition, inter-satellite interference can be effectively reduced to effectively increase the ground capacity.

In some embodiments, the second communication apparatus 130 further sends (for example, as shown by the number 240 in FIG. 2) the configuration information (for example, the configuration information 202 shown in FIG. 2) to the first communication apparatus 140. In this way, load balancing of satellites in the group can be ensured through simple configuration, and loads are effectively distributed to the satellites in the group. In other words, it can be ensured that the satellites in the group have a uniform spacing and a strong switching regularity, it can be ensured that the terminal device stays for similar time in a ground area unit served by each satellite, and stays for as long as possible in the ground area unit served by each satellite. In addition, regardless of protocol efficiency, switching overheads can be reduced proportionally.

In some embodiments, the switching may be switching between two satellite groups in the at least one satellite group. Additionally or alternatively, the switching may be switching between two satellites in one of the at least one satellite group. In this way, frequent switching in the large constellation can be reduced, and frequencies of inter-group switching and intra-group switching of the satellite group can be decoupled from the scale of the satellites before grouping, and are always kept in the low range. In addition, inter-satellite interference can be effectively reduced to effectively increase the ground capacity.

In some embodiments, the at least one satellite group has different latitudes of coverage areas. For example, more inter-orbit groups are introduced in an orbit in a high-latitude area than an orbit in a low-latitude area. In this way, inter-orbit switching is further reduced in the high-latitude area with a high satellite orbit density.

In some embodiments, the at least one satellite group may include an intra-orbit satellite group and an inter-orbit satellite group, satellites in the intra-orbit satellite group belong to a same orbit, and satellites in the inter-orbit satellite group belong to at least two different orbits. In this way, frequent switching in the large constellation can be reduced. In addition, inter-satellite interference can be effectively reduced to effectively increase the ground capacity.

In some embodiments, altitudes of satellites in a satellite group in the at least one satellite group are approximately the same. For example, a difference between the altitudes of the satellites in the satellite group in the at least one satellite group is lower than a threshold. Additionally or alternatively, inclinations of the satellites in the satellite group in the at least one satellite group are approximately the same. For example, a difference between the inclinations of the satellites in the satellite group in the at least one satellite group is lower than a threshold. Additionally or alternatively, all satellites in the satellite group in the at least one satellite group are in an ascending orbit or a descending orbit. Additionally or alternatively, switching intervals of the satellites in the satellite group in the at least one satellite group are approximately the same. For example, a difference between the switching intervals of the satellites in the satellite group in the at least one satellite group is lower than a threshold. Additionally or alternatively, intra-orbit spacings of the satellites in the satellite group in the at least one satellite group are approximately the same. For example, a difference between the intra-orbit spacings of the satellites in the satellite group in the at least one satellite group is lower than a threshold. Additionally or alternatively, inter-orbit spacings of the satellites in the satellite group in the at least one satellite group are approximately the same. For example, a difference between the inter-orbit spacings of the satellites in the satellite group in the at least one satellite group is lower than a threshold. Additionally or alternatively, loads of the satellites in the satellite group in the at least one satellite group are approximately equal. For example, a difference between the loads of the satellites in the satellite group in the at least one satellite group is lower than a threshold. Additionally or alternatively, the satellites in the satellite group in the at least one satellite group are capable of establishing an inter-satellite link. In this way, service stability of grouped satellites in a given area can be ensured, and it can be ensured that there is a short inter-satellite link between a same group of satellites, to ensure switching performance.

In some embodiments, the plurality of satellites may belong to a same large constellation, each of the at least one satellite group has a same quantity of orbits and a same quantity of satellites in each orbit, a quantity of orbits of the large constellation is divisible by the quantity of orbits of each satellite group, and a quantity of satellites in each orbit of the large constellation is divisible by the quantity of satellites in each orbit of each satellite group. In this way, it can be ensured that the satellites in the satellite group have the uniform spacing and the strong switching regularity, it can be ensured that the terminal device stays for similar time in the ground area unit served by each satellite, and stays for as long as possible in the ground area unit served by each satellite. In addition, regardless of protocol efficiency, switching overheads can be reduced proportionally.

In some embodiments, the quantity of orbits of the large constellation is M1, and the quantity of satellites in each of the M1 orbits is N1, where M1 and N1 are natural numbers; and a size of each of the at least one satellite group is M2×N2, where M1 mod M2=0, N1 mod N2=0, M2 represents the quantity of orbits of each satellite group, N2 represents the quantity of satellites in each orbit of each satellite group, and mod represents a modulo operation. In this way, it can be ensured that the satellites in the group have the uniform spacing and the strong switching regularity, it can be ensured that the terminal device stays for similar time in the ground area unit served by each satellite, and stays for as long as possible in the ground area unit served by each satellite. In addition, regardless of protocol efficiency, switching overheads can be reduced proportionally.

In some embodiments, a quantity of the at least one satellite group is (M1×N1)/(M2×N2)×2, where “×2” represents that a satellite in an ascending orbit and a satellite in a descending orbit belong to different satellite groups. In this way, it can be ensured that there may be a short inter-satellite link between a same group of satellites, to ensure switching performance.

In some embodiments, for a satellite group in the at least one satellite group, a correspondence between the ground area unit and an orbit to which a satellite in the satellite group belongs is based on a distance between a reference position of a ground area unit in the at least one ground area unit and the orbit. In addition, for the satellite group in the at least one satellite group, a correspondence between the ground area unit and the satellite group is based on a distance between the reference position and the satellite group. In this way, it can be ensured that the satellites in the satellite group have the uniform spacing and the strong switching regularity.

In some embodiments, a correspondence between the ground area unit and the orbit is based on a distance between the reference position and the orbit being less than or equal to a first distance threshold. Additionally or alternatively, a non-correspondence between the ground area unit and the orbit is based on a distance between the reference position and the orbit being greater than a first distance threshold. Alternatively, the correspondence between the ground area unit and the orbit is based on the distance between the reference position and the orbit being less than the first distance threshold. Additionally or alternatively, the non-correspondence between the ground area unit and the orbit is based on the distance between the reference position and the orbit being greater than or equal to the first distance threshold. In this way, it can be ensured that the satellites in the satellite group have the uniform spacing and the strong switching regularity.

In some embodiments, a correspondence between the ground area unit and the satellite in the satellite group is based on a distance between the reference position and the satellite in the satellite group being less than or equal to a second distance threshold, where the satellite in the satellite group provides a communication service for a first communication apparatus in the ground area unit. Additionally or alternatively, a non-correspondence between the ground area unit and the satellite in the satellite group is based on a distance between the reference position and the satellite in the satellite group being greater than a second distance threshold, where the satellite in the satellite group does not provide a communication service for a first communication apparatus in the ground area unit. Alternatively, the correspondence between the ground area unit and the satellite in the satellite group is based on the distance between the reference position and the satellite in the satellite group being less than the second distance threshold. Additionally or alternatively, the non-correspondence between the ground area unit and the satellite in the satellite group is based on the distance between the reference position and the satellite in the satellite group being greater than or equal to the second distance threshold. In this way, it can be ensured that the satellites in the satellite group have the uniform spacing and the strong switching regularity.

In some embodiments, the distance between the reference position and the satellite group is a distance between the reference position and a central position of the satellite group, and the reference position is a central point of the ground area unit. In this way, it can be ensured that the satellites in the satellite group have the uniform spacing and the strong switching regularity.

In some embodiments, the configuration information includes a ground area unit served by a satellite in the satellite group in the at least one satellite group. Additionally or alternatively, the configuration information includes a trigger rule for switching of the satellite group. In this way, load balancing of satellites in the group can be ensured through simple configuration, and loads are effectively distributed to the satellites in the group. In other words, it can be ensured that the satellites in the group have the uniform spacing and the strong switching regularity, it can be ensured that the terminal device stays for similar time in the ground area unit served by each satellite, and stays for as long as possible in the ground area unit served by each satellite. In addition, regardless of protocol efficiency, switching overheads can be reduced proportionally.

In some embodiments, the trigger rule includes: a latitude of a position of the first communication apparatus in the ground area unit exceeds a threshold. Additionally or alternatively, the trigger rule includes: the satellite in the satellite group switches between an ascending orbit and a descending orbit relative to a movement trajectory of the first communication apparatus in the ground area unit. Additionally or alternatively, the trigger rule includes: time during which the satellite group provides the communication service for the first communication apparatus in the ground area unit exceeds a threshold. In this way, load balancing of satellites in the group can be ensured, and loads are effectively distributed to the satellites in the group. In other words, it can be ensured that the satellites in the group have the uniform spacing and the strong switching regularity, it can be ensured that the terminal device stays for similar time in the ground area unit served by each satellite, and stays for as long as possible in the ground area unit served by each satellite. In addition, regardless of protocol efficiency, switching overheads can be reduced proportionally.

In some embodiments, a length of the ground area unit in the at least one ground area unit in a movement direction of a first satellite in the satellite group in the at least one satellite group is not greater than half of an overlapping area of coverage areas of two adjacent satellites in an orbit to which the first satellite belongs before the first satellite is grouped. In this way, a proper size of the ground area unit can be set in a satellite movement direction.

In some embodiments, a length of the ground area unit in the at least one ground area unit in an earth rotation direction is not greater than half of an overlapping area of coverage areas of two adjacent satellites in an orbit to which a second satellite belongs before the second satellite in the satellite group in the at least one satellite group is grouped. In this way, a proper size of the ground area unit can be set in the earth rotation direction.

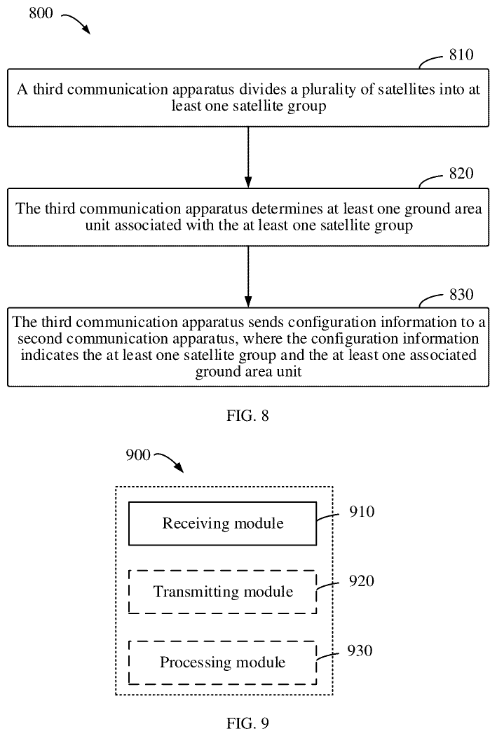

FIG. 8 is a flowchart of a method 800 implemented at a third communication apparatus according to some embodiments. In a possible implementation, the method 800 may be implemented by the third communication apparatus 110 in the communication system 100A shown in FIG. 1 or the network control unit 510 shown in FIG. 5. In another possible implementation, the method 800 may alternatively be implemented by another electronic apparatus independent of the communication system 100A. In an example, the method 800 is described below by using an example in which the method 800 is implemented by the third communication apparatus 110 in the communication system 100A.

At 810, the third communication apparatus 110 divides a plurality of satellites (for example, 3,360 satellites included in the 5^{th} layer of satellite constellation in the plurality of layers of satellite constellations shown in Table 1) into at least one satellite group (for example, 16 groups or 32 groups). At 820, the third communication apparatus 110 determines at least one ground area unit associated with the at least one satellite group. At 830, the third communication apparatus 110 sends configuration information (for example, the configuration information 201 shown in FIG. 2) to a second communication apparatus 130, where the configuration information indicates the at least one satellite group and the at least one associated ground area unit. In this way, frequent switching in a large constellation can be reduced, and frequencies of inter-group switching and intra-group switching of a satellite group can be decoupled from a scale of satellites before grouping, and are always kept in a low range. In addition, inter-satellite interference can be effectively reduced to effectively increase a ground capacity.

In some embodiments, the at least one satellite group has different latitudes of coverage areas. For example, more inter-orbit groups are introduced in an orbit in a high-latitude area than an orbit in a low-latitude area. In this way, inter-orbit switching is further reduced in the high-latitude area with a high satellite orbit density.

In some embodiments, the at least one satellite group may include an intra-orbit satellite group and an inter-orbit satellite group, satellites in the intra-orbit satellite group belong to a same orbit, and satellites in the inter-orbit satellite group belong to at least two different orbits. In this way, frequent switching in the large constellation can be reduced. In addition, inter-satellite interference can be effectively reduced to effectively increase the ground capacity.

In some embodiments, altitudes of satellites in a satellite group in the at least one satellite group are approximately the same. For example, a difference between the altitudes of the satellites in the satellite group in the at least one satellite group is lower than a threshold. Additionally or alternatively, inclinations of the satellites in the satellite group in the at least one satellite group are approximately the same. For example, a difference between the inclinations of the satellites in the satellite group in the at least one satellite group is lower than a threshold. Additionally or alternatively, all satellites in the satellite group in the at least one satellite group are in an ascending orbit or a descending orbit. Additionally or alternatively, switching intervals of the satellites in the satellite group in the at least one satellite group are approximately the same. For example, a difference between the switching intervals of the satellites in the satellite group in the at least one satellite group is lower than a threshold. Additionally or alternatively, intra-orbit spacings of the satellites in the satellite group in the at least one satellite group are approximately the same. For example, a difference between the intra-orbit spacings of the satellites in the satellite group in the at least one satellite group is lower than a threshold. Additionally or alternatively, inter-orbit spacings of the satellites in the satellite group in the at least one satellite group are approximately the same. For example, a difference between the inter-orbit spacings of the satellites in the satellite group in the at least one satellite group is lower than a threshold. Additionally or alternatively, loads of the satellites in the satellite group in the at least one satellite group are approximately equal. For example, a difference between the loads of the satellites in the satellite group in the at least one satellite group is lower than a threshold. Additionally or alternatively, the satellites in the satellite group in the at least one satellite group are capable of establishing an inter-satellite link. In this way, service stability of grouped satellites in a given area can be ensured, and it can be ensured that there is a short inter-satellite link between a same group of satellites, to ensure switching performance.

In some embodiments, the plurality of satellites may belong to a same large constellation, each of the at least one satellite group has a same quantity of orbits and a same quantity of satellites in each orbit, a quantity of orbits of the large constellation is divisible by the quantity of orbits of each satellite group, and a quantity of satellites in each orbit of the large constellation is divisible by the quantity of satellites in each orbit of each satellite group. In this way, it can be ensured that the satellites in the satellite group have a uniform spacing and a strong switching regularity, it can be ensured that the terminal device stays for similar time in a ground area unit served by each satellite, and stays for as long as possible in the ground area unit served by each satellite. In addition, regardless of protocol efficiency, switching overheads can be reduced proportionally.

In some embodiments, the quantity of orbits of the large constellation is M1, and the quantity of satellites in each of the M1 orbits is N1, where M1 and N1 are natural numbers; and a size of each of the at least one satellite group is M2×N2, where M1 mod M2=0, N1 mod N2=0, M2 represents the quantity of orbits of each satellite group, N2 represents the quantity of satellites in each orbit of each satellite group, and mod represents a modulo operation. In this way, it can be ensured that the satellites in the group have the uniform spacing and the strong switching regularity, it can be ensured that the terminal device stays for similar time in the ground area unit served by each satellite, and stays for as long as possible in the ground area unit served by each satellite. In addition, regardless of protocol efficiency, switching overheads can be reduced proportionally.

In some embodiments, a quantity of the at least one satellite group is (M1×N1)/(M2×N2)×2, where “×2” represents that a satellite in an ascending orbit and a satellite in a descending orbit belong to different satellite groups. In this way, it can be ensured that there may be a short inter-satellite link between a same group of satellites, to ensure switching performance.

In some embodiments, for a satellite group in the at least one satellite group, the third communication apparatus 110 may determine, based on a distance between a reference position of a ground area unit in the at least one ground area unit and an orbit, a correspondence between the ground area unit and the orbit to which a satellite in the satellite group belongs. In addition, for the satellite group in the at least one satellite group, the third communication apparatus 110 may determine a correspondence between the ground area unit and the satellite group based on a distance between the reference position and the satellite group. In this way, for the satellite group in the at least one satellite group, the correspondence between the ground area unit and the orbit to which the satellite in the satellite group belongs is based on the distance between the reference position of the ground area unit in the at least one ground area unit and the orbit. In addition, for the satellite group in the at least one satellite group, the correspondence between the ground area unit and the satellite group is based on the distance between the reference position and the satellite group. In this way, it can be ensured that the satellites in the satellite group have the uniform spacing and the strong switching regularity.

In some embodiments, the third communication apparatus 110 may determine the correspondence between the ground area unit and the orbit based on the distance between the reference position and the orbit being less than or equal to a first distance threshold. Additionally or alternatively, the third communication apparatus 110 may determine the non-correspondence between the ground area unit and the orbit based on the distance between the reference position and the orbit being greater than the first distance threshold. Alternatively, the third communication apparatus 110 may determine the correspondence between the ground area unit and the orbit based on the distance between the reference position and the orbit being less than the first distance threshold. Additionally or alternatively, the third communication apparatus 110 may determine the non-correspondence between the ground area unit and the orbit based on the distance between the reference position and the orbit being greater than or equal to the first distance threshold. In this way, the correspondence between the ground area unit and the orbit is based on the distance between the reference position and the orbit being less than or equal to the first distance threshold. Additionally or alternatively, the non-correspondence between the ground area unit and the orbit is based on the distance between the reference position and the orbit being greater than the first distance threshold. Alternatively, the correspondence between the ground area unit and the orbit is based on the distance between the reference position and the orbit being less than the first distance threshold. Additionally or alternatively, the non-correspondence between the ground area unit and the orbit is based on the distance between the reference position and the orbit being greater than or equal to the first distance threshold. In this way, it can be ensured that the satellites in the satellite group have the uniform spacing and the strong switching regularity.

In some embodiments, the third communication apparatus 110 may determine a correspondence between the ground area unit and the satellite in the satellite group based on a distance between the reference position and the satellite in the satellite group being less than or equal to a second distance threshold, where the satellite in the satellite group provides a communication service for a first communication apparatus in the ground area unit. Additionally or alternatively, the third communication apparatus 110 may determine a non-correspondence between the ground area unit and the satellite in the satellite group based on a distance between the reference position and the satellite in the satellite group being greater than a second distance threshold, where the satellite in the satellite group does not provide a communication service for a first communication apparatus in the ground area unit. Alternatively, the third communication apparatus 110 may determine the correspondence between the ground area unit and the satellite in the satellite group based on the distance between the reference position and the satellite in the satellite group being less than the second distance threshold. Additionally or alternatively, the third communication apparatus 110 may determine the non-correspondence between the ground area unit and the satellite in the satellite group based on the distance between the reference position and the satellite in the satellite group being greater than or equal to the second distance threshold. In this way, the correspondence between the ground area unit and the satellite in the satellite group is based on the distance between the reference position and the satellite in the satellite group being less than or equal to the second distance threshold, where the satellite in the satellite group provides the communication service for the first communication apparatus in the ground area unit. Additionally or alternatively, the non-correspondence between the ground area unit and the satellite in the satellite group is based on the distance between the reference position and the satellite in the satellite group being greater than the second distance threshold, where the satellite in the satellite group does not provide the communication service for the first communication apparatus in the ground area unit. Alternatively, the correspondence between the ground area unit and the satellite in the satellite group is based on the distance between the reference position and the satellite in the satellite group being less than the second distance threshold. Additionally or alternatively, the non-correspondence between the ground area unit and the satellite in the satellite group is based on the distance between the reference position and the satellite in the satellite group being greater than or equal to the second distance threshold. In this way, it can be ensured that the satellites in the satellite group have the uniform spacing and the strong switching regularity.

In some embodiments, the distance between the reference position and the satellite group is a distance between the reference position and a central position of the satellite group, and the reference position is a central point of the ground area unit. In this way, it can be ensured that the satellites in the satellite group have the uniform spacing and the strong switching regularity.

In some embodiments, the configuration information includes a ground area unit served by a satellite in the satellite group in the at least one satellite group. Additionally or alternatively, the configuration information includes a trigger rule for switching of the satellite group. For example, as shown in FIG. 2, the third communication apparatus 110 may simultaneously send (230) the ground area unit and the trigger rule to the second communication apparatus 130. Alternatively, the third communication apparatus 110 may separately send (230) one of the ground area unit and the trigger rule to the second communication apparatus 130, or the third communication apparatus 110 may send (230) the ground area unit and the trigger rule to the second communication apparatus 130 in sequence. At the second communication apparatus 130, the second communication apparatus 130 may simultaneously send (240) the ground area unit and the trigger rule to the first communication apparatus 140. Alternatively, the second communication apparatus 130 may separately send (240) one of the ground area unit and the trigger rule to the first communication apparatus 140, or the second communication apparatus 130 may send (240) the ground area unit and the trigger rule to the first communication apparatus 140 in sequence. In this way, load balancing of satellites in the group can be ensured through simple configuration, and loads are effectively distributed to the satellites in the group. In other words, it can be ensured that the satellites in the group have the uniform spacing and the strong switching regularity, it can be ensured that the terminal device stays for similar time in the ground area unit served by each satellite, and stays for as long as possible in the ground area unit served by each satellite. In addition, regardless of protocol efficiency, switching overheads can be reduced proportionally.

In some embodiments, the trigger rule includes: a latitude of a position of the first communication apparatus in the ground area unit exceeds a threshold. Additionally or alternatively, the trigger rule includes: the satellite in the satellite group switches between an ascending orbit and a descending orbit relative to a movement trajectory of the first communication apparatus in the ground area unit. Additionally or alternatively, the trigger rule includes: time during which the satellite group provides the communication service for the first communication apparatus in the ground area unit exceeds a threshold. In this way, load balancing of satellites in the group can be ensured, and loads are effectively distributed to the satellites in the group. In other words, it can be ensured that the satellites in the group have the uniform spacing and the strong switching regularity, it can be ensured that the terminal device stays for similar time in the ground area unit served by each satellite, and stays for as long as possible in the ground area unit served by each satellite. In addition, regardless of protocol efficiency, switching overheads can be reduced proportionally.

In some embodiments, the third communication apparatus 110 may determine a ground area unit in the at least one ground area unit, so that a length of the ground area unit in a movement direction of a first satellite in the satellite group in the at least one satellite group is not greater than half of an overlapping area of coverage areas of two adjacent satellites in an orbit to which the first satellite belongs before the first satellite is grouped. In this way, the length of the ground area unit in the at least one ground area unit in the movement direction of the first satellite in the satellite group in the at least one satellite group is not greater than half of the overlapping area of the coverage areas of the two adjacent satellites in the orbit to which the first satellite belongs before the first satellite is grouped. In this way, a proper size of the ground area unit can be set in a satellite movement direction.

In some embodiments, the third communication apparatus 110 may determine a ground area unit in the at least one ground area unit, so that a length of the ground area unit in an earth rotation direction is not greater than half of an overlapping area of coverage areas of two adjacent satellites in an orbit to which a second satellite belongs before the second satellite in the satellite group in the at least one satellite group is grouped. In this way, the length of the ground area unit in the at least one ground area unit in the earth rotation direction is not greater than half of the overlapping area of the coverage areas of the two adjacent satellites in the orbit to which the second satellite belongs before the second satellite in the satellite group in the at least one satellite group is grouped. In this way, a proper size of the ground area unit can be set in the earth rotation direction.

FIG. 9 is a block diagram of a first communication apparatus 900 according to some embodiments. The first communication apparatus 900 may be implemented as a device or a chip in the device, and the scope of the embodiments is not limited in this aspect. The first communication apparatus 900 may include a plurality of modules to perform corresponding processing in the method 600 discussed in FIG. 6. The first communication apparatus 900 may be implemented as the first communication apparatus 140 shown in FIG. 1. The following describes FIG. 9 with reference to FIG. 1, FIG. 2, and FIG. 6.

As shown in FIG. 9, the first communication apparatus 900 includes a receiving module 910. In some embodiments, the first communication apparatus 900 may further include a transmitting module 920 and a processing module 930. The receiving module 910 is configured to receive data, the transmitting module 920 is configured to send data, and the processing module 930 is configured to process data. For example, the receiving module 910 is configured to receive configuration information (for example, the configuration information 202 shown in FIG. 2) from a second communication apparatus 130, where the configuration information indicates at least one satellite group and at least one ground area unit associated with the at least one satellite group. The transmitting module 920 is configured to send communication data to the second communication apparatus 130. In this way, frequent switching in a large constellation can be reduced, and frequencies of inter-group switching and intra-group switching of a satellite group can be decoupled from a scale of satellites before grouping, and are always kept in a low range. In addition, inter-satellite interference can be effectively reduced to effectively increase a ground capacity.

In some embodiments, the first communication apparatus 140 may be or include a terminal device. Alternatively, the first communication apparatus 140 may be or include a chip in the terminal device. In this way, the first communication apparatus 140 can be implemented in a plurality of forms based on requirements in various application scenarios, to implement a function of the first communication apparatus 140.

In some embodiments, the at least one satellite group has different latitudes of coverage areas. For example, more inter-orbit groups are introduced in an orbit in a high-latitude area than an orbit in a low-latitude area. In this way, inter-orbit switching is further reduced in the high-latitude area with a high satellite orbit density.

In some embodiments, the at least one satellite group may include an intra-orbit satellite group and an inter-orbit satellite group, satellites in the intra-orbit satellite group belong to a same orbit, and satellites in the inter-orbit satellite group belong to at least two different orbits. In this way, frequent switching in the large constellation can be reduced. In addition, inter-satellite interference can be effectively reduced to effectively increase the ground capacity.

In some embodiments, altitudes of satellites in a satellite group in the at least one satellite group are approximately the same. For example, a difference between the altitudes of the satellites in the satellite group in the at least one satellite group is lower than a threshold. Additionally or alternatively, inclinations of the satellites in the satellite group in the at least one satellite group are approximately the same. For example, a difference between the inclinations of the satellites in the satellite group in the at least one satellite group is lower than a threshold. Additionally or alternatively, all satellites in the satellite group in the at least one satellite group are in an ascending orbit or a descending orbit. Additionally or alternatively, switching intervals of the satellites in the satellite group in the at least one satellite group are approximately the same.

For example, a difference between the switching intervals of the satellites in the satellite group in the at least one satellite group is lower than a threshold. Additionally or alternatively, intra-orbit spacings of the satellites in the satellite group in the at least one satellite group are approximately the same. For example, a difference between the intra-orbit spacings of the satellites in the satellite group in the at least one satellite group is lower than a threshold. Additionally or alternatively, inter-orbit spacings of the satellites in the satellite group in the at least one satellite group are approximately the same. For example, a difference between the inter-orbit spacings of the satellites in the satellite group in the at least one satellite group is lower than a threshold. Additionally or alternatively, loads of the satellites in the satellite group in the at least one satellite group are approximately equal. For example, a difference between the loads of the satellites in the satellite group in the at least one satellite group is lower than a threshold. Additionally or alternatively, the satellites in the satellite group in the at least one satellite group are capable of establishing an inter-satellite link. In this way, service stability of grouped satellites in a given area can be ensured, and it can be ensured that there is a short inter-satellite link between a same group of satellites, to ensure switching performance.

In some embodiments, the plurality of satellites may belong to a same large constellation, each of the at least one satellite group has a same quantity of orbits and a same quantity of satellites in each orbit, a quantity of orbits of the large constellation is divisible by the quantity of orbits of each satellite group, and a quantity of satellites in each orbit of the large constellation is divisible by the quantity of satellites in each orbit of each satellite group. In this way, it can be ensured that the satellites in the satellite group have a uniform spacing and a strong switching regularity, it can be ensured that the terminal device stays for similar time in a ground area unit served by each satellite, and stays for as long as possible in the ground area unit served by each satellite. In addition, regardless of protocol efficiency, switching overheads can be reduced proportionally.

In some embodiments, the quantity of orbits of the large constellation is M1, and the quantity of satellites in each of the M1 orbits is N1, where M1 and N1 are natural numbers; and a size of each of the at least one satellite group is M2×N2, where M1 mod M2=0, N1 mod N2=0, M2 represents the quantity of orbits of each satellite group, N2 represents the quantity of satellites in each orbit of each satellite group, and mod represents a modulo operation. In this way, it can be ensured that the satellites in the group have the uniform spacing and the strong switching regularity, it can be ensured that the terminal device stays for similar time in the ground area unit served by each satellite, and stays for as long as possible in the ground area unit served by each satellite. In addition, regardless of protocol efficiency, switching overheads can be reduced proportionally.

In some embodiments, a quantity of the at least one satellite group is (M1×N1)/(M2×N2)×2, where “×2” represents that a satellite in an ascending orbit and a satellite in a descending orbit belong to different satellite groups. In this way, it can be ensured that there may be a short inter-satellite link between a same group of satellites, to ensure switching performance.

In some embodiments, for a satellite group in the at least one satellite group, a correspondence between the ground area unit and an orbit to which a satellite in the satellite group belongs is based on a distance between a reference position of a ground area unit in the at least one ground area unit and the orbit. In addition, for the satellite group in the at least one satellite group, a correspondence between the ground area unit and the satellite group is based on a distance between the reference position and the satellite group. In this way, it can be ensured that the satellites in the satellite group have the uniform spacing and the strong switching regularity.

In some embodiments, a correspondence between the ground area unit and the orbit is based on a distance between the reference position and the orbit being less than or equal to a first distance threshold. Additionally or alternatively, a non-correspondence between the ground area unit and the orbit is based on a distance between the reference position and the orbit being greater than a first distance threshold. Alternatively, the correspondence between the ground area unit and the orbit is based on the distance between the reference position and the orbit being less than the first distance threshold. Additionally or alternatively, the non-correspondence between the ground area unit and the orbit is based on the distance between the reference position and the orbit being greater than or equal to the first distance threshold. In this way, it can be ensured that the satellites in the satellite group have the uniform spacing and the strong switching regularity.

In some embodiments, a correspondence between the ground area unit and the satellite in the satellite group is based on a distance between the reference position and the satellite in the satellite group being less than or equal to a second distance threshold, where the satellite in the satellite group provides a communication service for a first communication apparatus in the ground area unit. Additionally or alternatively, a non-correspondence between the ground area unit and the satellite in the satellite group is based on a distance between the reference position and the satellite in the satellite group being greater than a second distance threshold, where the satellite in the satellite group does not provide a communication service for a first communication apparatus in the ground area unit. Alternatively, the correspondence between the ground area unit and the satellite in the satellite group is based on the distance between the reference position and the satellite in the satellite group being less than the second distance threshold. Additionally or alternatively, the non-correspondence between the ground area unit and the satellite in the satellite group is based on the distance between the reference position and the satellite in the satellite group being greater than or equal to the second distance threshold. In this way, it can be ensured that the satellites in the satellite group have the uniform spacing and the strong switching regularity.

In some embodiments, the distance between the reference position and the satellite group is a distance between the reference position and a central position of the satellite group, and the reference position is a central point of the ground area unit. In this way, it can be ensured that the satellites in the satellite group have the uniform spacing and the strong switching regularity.

In some embodiments, the configuration information includes a ground area unit served by a satellite in the satellite group in the at least one satellite group. Additionally or alternatively, the configuration information includes a trigger rule for switching of the satellite group. In this way, load balancing of satellites in the group can be ensured through simple configuration, and loads are effectively distributed to the satellites in the group. In other words, it can be ensured that the satellites in the group have the uniform spacing and the strong switching regularity, it can be ensured that the terminal device stays for similar time in the ground area unit served by each satellite, and stays for as long as possible in the ground area unit served by each satellite. In addition, regardless of protocol efficiency, switching overheads can be reduced proportionally.

In some embodiments, the trigger rule includes: a latitude of a position of the first communication apparatus in the ground area unit exceeds a threshold. Additionally or alternatively, the trigger rule includes: the satellite in the satellite group switches between an ascending orbit and a descending orbit relative to a movement trajectory of the first communication apparatus in the ground area unit. Additionally or alternatively, the trigger rule includes: time during which the satellite group provides the communication service for the first communication apparatus in the ground area unit exceeds a threshold. In this way, load balancing of satellites in the group can be ensured, and loads are effectively distributed to the satellites in the group. In other words, it can be ensured that the satellites in the group have the uniform spacing and the strong switching regularity, it can be ensured that the terminal device stays for similar time in the ground area unit served by each satellite, and stays for as long as possible in the ground area unit served by each satellite. In addition, regardless of protocol efficiency, switching overheads can be reduced proportionally.

In some embodiments, a length of the ground area unit in the at least one ground area unit in a movement direction of a first satellite in the satellite group in the at least one satellite group is not greater than half of an overlapping area of coverage areas of two adjacent satellites in an orbit to which the first satellite belongs before the first satellite is grouped. In this way, a proper size of the ground area unit can be set in a satellite movement direction.

In some embodiments, a length of the ground area unit in the at least one ground area unit in an earth rotation direction is not greater than half of an overlapping area of coverage areas of two adjacent satellites in an orbit to which a second satellite belongs before the second satellite in the satellite group in the at least one satellite group is grouped. In this way, a proper size of the ground area unit can be set in the earth rotation direction.

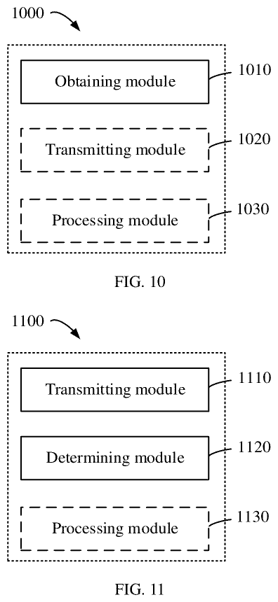

FIG. 10 is a block diagram of a second communication apparatus 1000 according to some other embodiments. The second communication apparatus 1000 may be implemented as a device or a chip in the device, and the scope of the embodiments is not limited in this aspect. The second communication apparatus 1000 may include a plurality of modules to perform corresponding processing in the method 700 discussed in FIG. 7. The second communication apparatus 1000 may be implemented as shown in FIG. 1. The following describes FIG. 10 with reference to FIG. 1, FIG. 2, and FIG. 7.

As shown in FIG. 10, the second communication apparatus 1000 includes an obtaining module 1010. In some embodiments, the second communication apparatus 1000 may further include a transmitting module 1020 and/or a processing module 1030. The obtaining module 1010 is configured to obtain data, the transmitting module 1020 is configured to send data, and the processing module 1030 is configured to process data. For example, the obtaining module 1010 is configured to obtain information indicating at least one satellite group and at least one ground area unit associated with the at least one satellite group. In some embodiments, the transmitting module 1020 may be configured to send the configuration information to a first communication apparatus 140. For example, the second communication apparatus 130 in FIG. 2 sends (240) the configuration information 202 to the first communication apparatus 140. In this way, frequent switching in a large constellation can be reduced, and frequencies of inter-group switching and intra-group switching of a satellite group can be decoupled from a scale of satellites before grouping, and are always kept in a low range. In addition, inter-satellite interference can be effectively reduced to effectively increase a ground capacity.

In some embodiments, as described above, the obtaining module 1010 may include a receiving module. To obtain the information, the receiving module may receive configuration information (for example, the configuration information 201 shown in FIG. 2) from a third communication apparatus 110. The configuration information indicates the at least one satellite group and the at least one ground area unit associated with the at least one satellite group. In this way, frequent switching in the large constellation can be reduced, and frequencies of inter-group switching and intra-group switching of the satellite group can be decoupled from the scale of the satellites before grouping, and are always kept in the low range. In addition, inter-satellite interference can be effectively reduced to effectively increase the ground capacity.

In some embodiments, as described above, the transmitting module 1020 may send (for example, as shown by the number 240 in FIG. 2) the configuration information (for example, the configuration information 202 shown in FIG. 2) to the first communication apparatus 140. In this way, load balancing of satellites in the group can be ensured through simple configuration, and loads are effectively distributed to the satellites in the group. In other words, it can be ensured that the satellites in the group have a uniform spacing and a strong switching regularity, it can be ensured that the terminal device stays for similar time in a ground area unit served by each satellite, and stays for as long as possible in the ground area unit served by each satellite. In addition, regardless of protocol efficiency, switching overheads can be reduced proportionally.

In some embodiments, the switching may be switching between two satellite groups in the at least one satellite group. Additionally or alternatively, the switching may be switching between two satellites in one of the at least one satellite group. In this way, frequent switching in the large constellation can be reduced, and frequencies of inter-group switching and intra-group switching of the satellite group can be decoupled from the scale of the satellites before grouping, and are always kept in the low range. In addition, inter-satellite interference can be effectively reduced to effectively increase the ground capacity.

In some embodiments, the at least one satellite group has different latitudes of coverage areas. For example, more inter-orbit groups are introduced in an orbit in a high-latitude area than an orbit in a low-latitude area. In this way, inter-orbit switching is further reduced in the high-latitude area with a high satellite orbit density.

In some embodiments, the at least one satellite group may include an intra-orbit satellite group and an inter-orbit satellite group, satellites in the intra-orbit satellite group belong to a same orbit, and satellites in the inter-orbit satellite group belong to at least two different orbits. In this way, frequent switching in the large constellation can be reduced. In addition, inter-satellite interference can be effectively reduced to effectively increase the ground capacity.

In some embodiments, altitudes of satellites in a satellite group in the at least one satellite group are approximately the same. For example, a difference between the altitudes of the satellites in the satellite group in the at least one satellite group is lower than a threshold. Additionally or alternatively, inclinations of the satellites in the satellite group in the at least one satellite group are approximately the same. For example, a difference between the inclinations of the satellites in the satellite group in the at least one satellite group is lower than a threshold. Additionally or alternatively, all satellites in the satellite group in the at least one satellite group are in an ascending orbit or a descending orbit. Additionally or alternatively, switching intervals of the satellites in the satellite group in the at least one satellite group are approximately the same. For example, a difference between the switching intervals of the satellites in the satellite group in the at least one satellite group is lower than a threshold. Additionally or alternatively, intra-orbit spacings of the satellites in the satellite group in the at least one satellite group are approximately the same. For example, a difference between the intra-orbit spacings of the satellites in the satellite group in the at least one satellite group is lower than a threshold. Additionally or alternatively, inter-orbit spacings of the satellites in the satellite group in the at least one satellite group are approximately the same. For example, a difference between the inter-orbit spacings of the satellites in the satellite group in the at least one satellite group is lower than a threshold. Additionally or alternatively, loads of the satellites in the satellite group in the at least one satellite group are approximately equal. For example, a difference between the loads of the satellites in the satellite group in the at least one satellite group is lower than a threshold. Additionally or alternatively, the satellites in the satellite group in the at least one satellite group are capable of establishing an inter-satellite link. In this way, service stability of grouped satellites in a given area can be ensured, and it can be ensured that there is a short inter-satellite link between a same group of satellites, to ensure switching performance.

In some embodiments, the plurality of satellites may belong to a same large constellation, each of the at least one satellite group has a same quantity of orbits and a same quantity of satellites in each orbit, a quantity of orbits of the large constellation is divisible by the quantity of orbits of each satellite group, and a quantity of satellites in each orbit of the large constellation is divisible by the quantity of satellites in each orbit of each satellite group. In this way, it can be ensured that the satellites in the satellite group have a uniform spacing and a strong switching regularity, it can be ensured that the terminal device stays for similar time in a ground area unit served by each satellite, and stays for as long as possible in the ground area unit served by each satellite. In addition, regardless of protocol efficiency, switching overheads can be reduced proportionally.

In some embodiments, the quantity of orbits of the large constellation is M1, and the quantity of satellites in each of the M1 orbits is N1, where M1 and N1 are natural numbers; and a size of each of the at least one satellite group is M2×N2, where M1 mod M2=0, N1 mod N2=0, M2 represents the quantity of orbits of each satellite group, N2 represents the quantity of satellites in each orbit of each satellite group, and mod represents a modulo operation. In this way, it can be ensured that the satellites in the group have the uniform spacing and the strong switching regularity, it can be ensured that the terminal device stays for similar time in the ground area unit served by each satellite, and stays for as long as possible in the ground area unit served by each satellite. In addition, regardless of protocol efficiency, switching overheads can be reduced proportionally.

In some embodiments, a quantity of the at least one satellite group is (M1×N1)/(M2×N2)×2, where “×2” represents that a satellite in an ascending orbit and a satellite in a descending orbit belong to different satellite groups. In this way, it can be ensured that there may be a short inter-satellite link between a same group of satellites, to ensure switching performance.

In some embodiments, for a satellite group in the at least one satellite group, a correspondence between the ground area unit and an orbit to which a satellite in the satellite group belongs is based on a distance between a reference position of a ground area unit in the at least one ground area unit and the orbit. In addition, for the satellite group in the at least one satellite group, a correspondence between the ground area unit and the satellite group is based on a distance between the reference position and the satellite group. In this way, it can be ensured that the satellites in the satellite group have the uniform spacing and the strong switching regularity.

In some embodiments, a correspondence between the ground area unit and the orbit is based on a distance between the reference position and the orbit being less than or equal to a first distance threshold. Additionally or alternatively, a non-correspondence between the ground area unit and the orbit is based on a distance between the reference position and the orbit being greater than a first distance threshold. Alternatively, the correspondence between the ground area unit and the orbit is based on the distance between the reference position and the orbit being less than the first distance threshold. Additionally or alternatively, the non-correspondence between the ground area unit and the orbit is based on the distance between the reference position and the orbit being greater than or equal to the first distance threshold. In this way, it can be ensured that the satellites in the satellite group have the uniform spacing and the strong switching regularity.

In some embodiments, a correspondence between the ground area unit and the satellite in the satellite group is based on a distance between the reference position and the satellite in the satellite group being less than or equal to a second distance threshold, where the satellite in the satellite group provides a communication service for a first communication apparatus in the ground area unit. Additionally or alternatively, a non-correspondence between the ground area unit and the satellite in the satellite group is based on a distance between the reference position and the satellite in the satellite group being greater than a second distance threshold, where the satellite in the satellite group does not provide a communication service for a first communication apparatus in the ground area unit. Alternatively, the correspondence between the ground area unit and the satellite in the satellite group is based on the distance between the reference position and the satellite in the satellite group being less than the second distance threshold. Additionally or alternatively, the non-correspondence between the ground area unit and the satellite in the satellite group is based on the distance between the reference position and the satellite in the satellite group being greater than or equal to the second distance threshold. In this way, it can be ensured that the satellites in the satellite group have the uniform spacing and the strong switching regularity.

In some embodiments, the distance between the reference position and the satellite group is a distance between the reference position and a central position of the satellite group, and the reference position is a central point of the ground area unit. In this way, it can be ensured that the satellites in the satellite group have the uniform spacing and the strong switching regularity.

In some embodiments, the configuration information includes a ground area unit served by a satellite in the satellite group in the at least one satellite group. Additionally or alternatively, the configuration information includes a trigger rule for switching of the satellite group. In this way, load balancing of satellites in the group can be ensured through simple configuration, and loads are effectively distributed to the satellites in the group. In other words, it can be ensured that the satellites in the group have a uniform spacing and a strong switching regularity, it can be ensured that the terminal device stays for similar time in a ground area unit served by each satellite, and stays for as long as possible in the ground area unit served by each satellite. In addition, regardless of protocol efficiency, switching overheads can be reduced proportionally.

In some embodiments, the trigger rule includes: a latitude of a position of the first communication apparatus in the ground area unit exceeds a threshold. Additionally or alternatively, the trigger rule includes: the satellite in the satellite group switches between an ascending orbit and a descending orbit relative to a movement trajectory of the first communication apparatus in the ground area unit. Additionally or alternatively, the trigger rule includes: time during which the satellite group provides the communication service for the first communication apparatus in the ground area unit exceeds a threshold. In this way, load balancing of satellites in the group can be ensured, and loads are effectively distributed to the satellites in the group. In other words, it can be ensured that the satellites in the group have a uniform spacing and a strong switching regularity, it can be ensured that the terminal device stays for similar time in a ground area unit served by each satellite, and stays for as long as possible in the ground area unit served by each satellite. In addition, regardless of protocol efficiency, switching overheads can be reduced proportionally.

In some embodiments, a length of the ground area unit in the at least one ground area unit in a movement direction of a first satellite in the satellite group in the at least one satellite group is not greater than half of an overlapping area of coverage areas of two adjacent satellites in an orbit to which the first satellite belongs before the first satellite is grouped. In this way, a proper size of the ground area unit can be set in a satellite movement direction.

In some embodiments, a length of the ground area unit in the at least one ground area unit in an earth rotation direction is not greater than half of an overlapping area of coverage areas of two adjacent satellites in an orbit to which a second satellite belongs before the second satellite in the satellite group in the at least one satellite group is grouped. In this way, a proper size of the ground area unit can be set in the earth rotation direction.

FIG. 11 is a block diagram of a third communication apparatus 1100 according to some other embodiments. The third communication apparatus 1100 may be implemented as a device or a chip in the device, and the scope of the embodiments is not limited in this aspect. The third communication apparatus 1100 may include a plurality of modules to perform corresponding processing in the method 800 discussed in FIG. 8. The third communication apparatus 1100 may be implemented as the third communication apparatus 110 shown in FIG. 1. The following describes FIG. 11 with reference to FIG. 1, FIG. 2, and FIG. 8.

As shown in FIG. 11, the third communication apparatus 1100 includes a transmitting module 1110. In some embodiments, the third communication apparatus 1100 may further include a determining module 1120 and/or a processing module 1130. The transmitting module 1110 is configured to send data, the determining module 1120 is configured to determine data, and the processing module 1130 is configured to process data. For example, the processing module 1130 may be configured to divide a plurality of satellites into at least one satellite group, the determining module 1120 may be configured to determine at least one ground area unit associated with the at least one satellite group, and the transmitting module 1110 may be configured to send (for example, as shown by the number 230 in FIG. 2) configuration information (for example, the configuration information 201 shown in FIG. 2) to a second communication apparatus, where the configuration information indicates the at least one satellite group and the at least one associated ground area unit. In this way, frequent switching in a large constellation can be reduced, and frequencies of inter-group switching and intra-group switching of a satellite group can be decoupled from a scale of satellites before grouping, and are always kept in a low range. In addition, inter-satellite interference can be effectively reduced to effectively increase a ground capacity.

In some embodiments, the at least one satellite group has different latitudes of coverage areas. For example, more inter-orbit groups are introduced in an orbit in a high-latitude area than an orbit in a low-latitude area. In this way, inter-orbit switching is further reduced in the high-latitude area with a high satellite orbit density.

In some embodiments, the at least one satellite group may include an intra-orbit satellite group and an inter-orbit satellite group, satellites in the intra-orbit satellite group belong to a same orbit, and satellites in the inter-orbit satellite group belong to at least two different orbits. In this way, frequent switching in the large constellation can be reduced. In addition, inter-satellite interference can be effectively reduced to effectively increase the ground capacity.

In some embodiments, altitudes of satellites in a satellite group in the at least one satellite group are approximately the same. For example, a difference between the altitudes of the satellites in the satellite group in the at least one satellite group is lower than a threshold. Additionally or alternatively, inclinations of the satellites in the satellite group in the at least one satellite group are approximately the same. For example, a difference between the inclinations of the satellites in the satellite group in the at least one satellite group is lower than a threshold. Additionally or alternatively, all satellites in the satellite group in the at least one satellite group are in an ascending orbit or a descending orbit. Additionally or alternatively, switching intervals of the satellites in the satellite group in the at least one satellite group are approximately the same. For example, a difference between the switching intervals of the satellites in the satellite group in the at least one satellite group is lower than a threshold. Additionally or alternatively, intra-orbit spacings of the satellites in the satellite group in the at least one satellite group are approximately the same. For example, a difference between the intra-orbit spacings of the satellites in the satellite group in the at least one satellite group is lower than a threshold. Additionally or alternatively, inter-orbit spacings of the satellites in the satellite group in the at least one satellite group are approximately the same. For example, a difference between the inter-orbit spacings of the satellites in the satellite group in the at least one satellite group is lower than a threshold. Additionally or alternatively, loads of the satellites in the satellite group in the at least one satellite group are approximately equal. For example, a difference between the loads of the satellites in the satellite group in the at least one satellite group is lower than a threshold. Additionally or alternatively, the satellites in the satellite group in the at least one satellite group are capable of establishing an inter-satellite link. In this way, service stability of grouped satellites in a given area can be ensured, and it can be ensured that there is a short inter-satellite link between a same group of satellites, to ensure switching performance.

In some embodiments, the plurality of satellites may belong to a same large constellation, each of the at least one satellite group has a same quantity of orbits and a same quantity of satellites in each orbit, a quantity of orbits of the large constellation is divisible by the quantity of orbits of each satellite group, and a quantity of satellites in each orbit of the large constellation is divisible by the quantity of satellites in each orbit of each satellite group. In this way, it can be ensured that the satellites in the satellite group have a uniform spacing and a strong switching regularity, it can be ensured that the terminal device stays for similar time in a ground area unit served by each satellite, and stays for as long as possible in the ground area unit served by each satellite. In addition, regardless of protocol efficiency, switching overheads can be reduced proportionally.

In some embodiments, the quantity of orbits of the large constellation is M1, and the quantity of satellites in each of the M1 orbits is N1, where M1 and N1 are natural numbers; and a size of each of the at least one satellite group is M2×N2, where M1 mod M2=0, N1 mod N2=0, M2 represents the quantity of orbits of each satellite group, N2 represents the quantity of satellites in each orbit of each satellite group, and mod represents a modulo operation. In this way, it can be ensured that the satellites in the group have the uniform spacing and the strong switching regularity, it can be ensured that the terminal device stays for similar time in the ground area unit served by each satellite, and stays for as long as possible in the ground area unit served by each satellite. In addition, regardless of protocol efficiency, switching overheads can be reduced proportionally.

In some embodiments, a quantity of the at least one satellite group is (M1×N1)/(M2×N2)×2, where “×2” represents that a satellite in an ascending orbit and a satellite in a descending orbit belong to different satellite groups. In this way, it can be ensured that there may be a short inter-satellite link between a same group of satellites, to ensure switching performance.

In some embodiments, for a satellite group in the at least one satellite group, a correspondence between the ground area unit and an orbit to which a satellite in the satellite group belongs is based on a distance between a reference position of a ground area unit in the at least one ground area unit and the orbit. In addition, for the satellite group in the at least one satellite group, a correspondence between the ground area unit and the satellite group is based on a distance between the reference position and the satellite group. In this way, it can be ensured that the satellites in the satellite group have the uniform spacing and the strong switching regularity.

In some embodiments, a correspondence between the ground area unit and the orbit is based on a distance between the reference position and the orbit being less than or equal to a first distance threshold. Additionally or alternatively, a non-correspondence between the ground area unit and the orbit is based on a distance between the reference position and the orbit being greater than a first distance threshold. Alternatively, the correspondence between the ground area unit and the orbit is based on the distance between the reference position and the orbit being less than the first distance threshold. Additionally or alternatively, the non-correspondence between the ground area unit and the orbit is based on the distance between the reference position and the orbit being greater than or equal to the first distance threshold. In this way, it can be ensured that the satellites in the satellite group have the uniform spacing and the strong switching regularity.

In some embodiments, a correspondence between the ground area unit and the satellite in the satellite group is based on a distance between the reference position and the satellite in the satellite group being less than or equal to a second distance threshold, where the satellite in the satellite group provides a communication service for a first communication apparatus in the ground area unit. Additionally or alternatively, a non-correspondence between the ground area unit and the satellite in the satellite group is based on a distance between the reference position and the satellite in the satellite group being greater than a second distance threshold, where the satellite in the satellite group does not provide a communication service for a first communication apparatus in the ground area unit. Alternatively, the correspondence between the ground area unit and the satellite in the satellite group is based on the distance between the reference position and the satellite in the satellite group being less than the second distance threshold. Additionally or alternatively, the non-correspondence between the ground area unit and the satellite in the satellite group is based on the distance between the reference position and the satellite in the satellite group being greater than or equal to the second distance threshold. In this way, it can be ensured that the satellites in the satellite group have the uniform spacing and the strong switching regularity.

In some embodiments, the distance between the reference position and the satellite group is a distance between the reference position and a central position of the satellite group, and the reference position is a central point of the ground area unit. In this way, it can be ensured that the satellites in the satellite group have the uniform spacing and the strong switching regularity.

In some embodiments, the configuration information includes a ground area unit served by a satellite in the satellite group in the at least one satellite group. Additionally or alternatively, the configuration information includes a trigger rule for switching of the satellite group. In this way, load balancing of satellites in the group can be ensured through simple configuration, and loads are effectively distributed to the satellites in the group. In other words, it can be ensured that the satellites in the group have a uniform spacing and a strong switching regularity, it can be ensured that the terminal device stays for similar time in a ground area unit served by each satellite, and stays for as long as possible in the ground area unit served by each satellite. In addition, regardless of protocol efficiency, switching overheads can be reduced proportionally.

In some embodiments, the trigger rule includes: a latitude of a position of the first communication apparatus in the ground area unit exceeds a threshold. Additionally or alternatively, the trigger rule includes: the satellite in the satellite group switches between an ascending orbit and a descending orbit relative to a movement trajectory of the first communication apparatus in the ground area unit. Additionally or alternatively, the trigger rule includes: time during which the satellite group provides the communication service for the first communication apparatus in the ground area unit exceeds a threshold. In this way, load balancing of satellites in the group can be ensured, and loads are effectively distributed to the satellites in the group. In other words, it can be ensured that the satellites in the group have a uniform spacing and a strong switching regularity, it can be ensured that the terminal device stays for similar time in a ground area unit served by each satellite, and stays for as long as possible in the ground area unit served by each satellite. In addition, regardless of protocol efficiency, switching overheads can be reduced proportionally.

In some embodiments, a length of the ground area unit in the at least one ground area unit in a movement direction of a first satellite in the satellite group in the at least one satellite group is not greater than half of an overlapping area of coverage areas of two adjacent satellites in an orbit to which the first satellite belongs before the first satellite is grouped. In this way, a proper size of the ground area unit can be set in a satellite movement direction.

In some embodiments, a length of the ground area unit in the at least one ground area unit in an earth rotation direction is not greater than half of an overlapping area of coverage areas of two adjacent satellites in an orbit to which a second satellite belongs before the second satellite in the satellite group in the at least one satellite group is grouped. In this way, a proper size of the ground area unit can be set in the earth rotation direction.

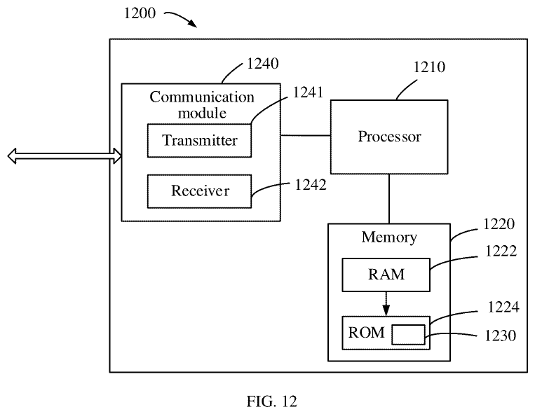

FIG. 12 is a simplified block diagram of an example device 1200 suitable for implementing embodiments. The device 1200 may be configured to implement the first communication apparatus 140, the second communication apparatus 130, the third communication apparatus 110, or the communication system 100A shown in FIG. 1A. As shown in the figure, the device 1200 includes one or more processors 1210, one or more memories 1220 coupled to the processors 1210, and a communication module 1240 coupled to the processor 1210. In some embodiments, the memory 1220 and the processor 1210 may be integrated together.

The communication module 1240 may be configured to perform bidirectional communication. The communication module 1240 may include a transmitter 1241 configured to send data and a receiver 1242 configured to receive data.

The processor 1210 may be of any type suitable for a local technology network, and may include but is not limited to at least one of the following: one or more of a general-purpose computer, a dedicated computer, a microcontroller, a digital signal processor (DSP), or a controller-based multi-core controller architecture. The device 1200 may have a plurality of processors, for example, application-specific integrated circuit chips, which in time belong to a clock synchronized with a main processor.

The memory 1220 may include one or more non-volatile memories and one or more volatile memories. An example of the non-volatile memory includes but is not limited to at least one of the following: a read-only memory (ROM) 1224, an erasable programmable read-only memory (EPROM), a flash memory, a hard disk, a compact disc (CD), a digital versatile disc (DVD), or another magnetic storage and/or optical storage. An example of the volatile memory includes but is not limited to at least one of the following: a random access memory (RAM) 1222, or another volatile memory that does not persist during power-off duration.

A computer program 1230 includes computer-executable instructions executed by the associated processor 1210. The program 1230 may be stored in the ROM 1224. The processor 1210 may perform any proper action and processing by loading the program 1230 into the RAM 1222.

The embodiments may be implemented by using the program 1230, so that the device 1200 can perform any process discussed with reference to FIG. 2 and FIG. 5 to FIG. 8. The embodiments may alternatively be implemented by hardware or a combination of software and hardware.

In some embodiments, the program 1230 may be tangibly included in a non-transitory computer-readable medium, and the non-transitory computer-readable medium may be included in the device 1200 (for example, in the memory 1220) or another storage device that can be accessed by the device 1200. The program 1230 may be loaded from the computer-readable medium into the RAM 1222 for execution. The computer-readable medium may include any type of tangible non-volatile memory, for example, a ROM, an EPROM, a flash memory, a hard disk, a CD, a DVD, or the like.

Various embodiments may be implemented by hardware or a dedicated circuit, software, logic, or any combination thereof. Some aspects may be implemented by hardware, and other aspects may be implemented by firmware or software, and may be executed by a controller, a microprocessor, or another computing device. Although aspects of embodiments are shown and described as block diagrams or flowcharts, or represented by some other illustrations, it should be understood that the blocks, apparatuses, systems, technologies, or methods described herein may be implemented as, for example, non-limiting examples, hardware, software, firmware, dedicated circuits or logic, general-purpose hardware, controllers, other computing devices, or a combination thereof.

The embodiments may further provide at least one computer program product tangibly stored on a non-transitory computer-readable storage medium. The computer program product includes computer-executable instructions, such as instructions included in a program module, executed in a device on a real or virtual target processor to perform the processes/methods as described above with reference to FIG. 4A to FIG. 9. In some embodiments, the program module includes a routine, a program, a library, an object, a class, a component, a data structure, or the like that executes a specific task or implements a specific abstract data type. In various embodiments, functions of the program modules may be combined or split between the program modules as required. Machine-executable instructions for the program module may be executed locally or in a distributed device. In the distributed device, the program module may be located in a local storage medium and a remote storage medium.

Computer program code for implementing the method may be written in one or more programming languages. The computer program code may be provided for a processor of a general-purpose computer, a dedicated computer, or another programmable data processing apparatus, so that when the program code is executed by the computer or the another programmable data processing apparatus, functions/operations specified in the flowcharts and/or block diagrams are implemented. The program code may be executed all on a computer, partially on a computer, as an independent software package, partially on a computer and partially on a remote computer, or all on a remote computer or server.

The computer program code or related data may be carried in any proper carrier, so that the device, the apparatus, or the processor can perform various processing and operations described above. Examples of the carrier include a signal, a computer-readable medium, and the like. Examples of the signal may include an electrical signal, an optical signal, a radio signal, a voice signal, or another form of propagated signal, such as a carrier wave and an infrared signal.

The computer-readable medium may be any tangible medium that includes or stores programs used for or related to an instruction execution system, apparatus, or device. The computer-readable medium may be a computer-readable signal medium or a computer-readable storage medium. The computer-readable medium may include but is not limited to an electronic, magnetic, optical, electromagnetic, infrared, or semiconductor system, apparatus or device, or any suitable combination thereof. More detailed examples of the computer-readable storage medium include an electrical connection with one or more wires, a portable computer disk, a hard disk, a random access memory (RAM), a read-only memory (ROM), an erasable programmable read-only memory (EPROM or a flash memory), an optical storage device, a magnetic storage device, or any suitable combination thereof.

In addition, although the operations of the methods are described in a particular order in the accompanying drawings, this does not require or imply that these operations need to be performed in the particular order or that all of the shown operations need to be performed to achieve a desired result. Instead, execution orders of the steps or operations depicted in the flowcharts may change. Additionally or alternatively, some steps or operations may be omitted, a plurality of steps or operations may be combined into one step or operation for execution, and/or one step or operation may be broken down into a plurality of steps or operations for execution. It should further be noted that features and functions of two or more apparatuses may be specific in one apparatus. Instead, features and functions of one apparatus described above may be further specific in a plurality of apparatuses.

The foregoing has described the embodiments. The foregoing descriptions are examples, are not exhaustive, and are not limited to the implementations herein. Without departing from the scope of the described implementations, many modifications and variations are apparent to a person of ordinary skill in the art. Selection of the terms used herein is intended to well explain principles of the implementations, actual applications, or improvements to technologies in the market, or to enable another person of ordinary skill in the art to understand the implementations herein.

1. A method comprising:
receiving, by a first communication apparatus, configuration information from a second communication apparatus, wherein the configuration information indicates at least one satellite group and at least one ground area unit associated with the at least one satellite group; and
performing, by the first communication apparatus, switching between a plurality of satellites in a satellite group in the at least one satellite group based on the configuration information, wherein the first communication apparatus is in a ground area unit associated with the satellite group.

2. The method according to claim 1, wherein the at least one satellite group has different latitudes of coverage areas.

3. The method according to claim 1, wherein the at least one satellite group comprises an intra-orbit satellite group and an inter-orbit satellite group, satellites in the intra-orbit satellite group belong to a same orbit, and satellites in the inter-orbit satellite group belong to at least two different orbits.

4. The method according to claim 1, wherein satellites in a satellite group in the at least one satellite group meet at least one of the following:
a difference between altitudes is lower than a threshold;
a difference between inclinations is lower than a threshold;
all satellites in the satellite group are in an ascending orbit or all satellites in the satellite group are in a descending orbit;
a difference between switching intervals is lower than a threshold;
a difference between intra-orbit spacings is lower than a threshold;
a difference between inter-orbit spacings is lower than a threshold;
a difference between loads is lower than a threshold; or
the satellites in the satellite group are configured to establish an inter-satellite link.

5. The method according to claim 1, wherein the plurality of satellites belongs to a same large constellation, each satellite group of the at least one satellite group has a same quantity of orbits and a same quantity of satellites in each orbit, a quantity of orbits of the large constellation is divisible by the quantity of orbits of each satellite group, and a quantity of satellites in each orbit of the large constellation is divisible by the quantity of satellites in each orbit of each satellite group.

6. The method according to claim 1, wherein the quantity of orbits of the large constellation is M1, and the quantity of satellites in each of the M1 orbits is N1, wherein M1 and N1 are natural numbers; and a size of each of the at least one satellite group is M2×N2, wherein M1 mod M2=0, N1 mod N2=0, M2 represents the quantity of orbits of each satellite group, N2 represents the quantity of satellites in each orbit of each satellite group, and mod represents a modulo operation.

7. The method according to claim 6, wherein a quantity of the at least one satellite group is (M1×N1)/(M2×N2)×2, wherein “×2” represents that a satellite in an ascending orbit and a satellite in a descending orbit belong to different satellite groups.

8. An apparatus comprising:
at least one processor; and
one or more memories coupled to the at least one processor and storing programming instructions for execution by the at least one processor to:
receive configuration information from a second communication apparatus, wherein the configuration information indicates at least one satellite group and at least one ground area unit associated with the at least one satellite group; and
perform switching between a plurality of satellites in a satellite group in the at least one satellite group based on the configuration information, wherein the apparatus is in a ground area unit associated with the satellite group.

9. The apparatus according to claim 8, wherein the at least one satellite group has different latitudes of coverage areas.

10. The apparatus according to claim 8, wherein the at least one satellite group comprises an intra-orbit satellite group and an inter-orbit satellite group, satellites in the intra-orbit satellite group belong to a same orbit, and satellites in the inter-orbit satellite group belong to at least two different orbits.

11. The apparatus according to claim 8, wherein satellites in a satellite group in the at least one satellite group meet at least one of the following:
a difference between altitudes is lower than a threshold;
a difference between inclinations is lower than a threshold;
all satellites in the satellite group are in an ascending orbit or all satellites in the satellite group are in a descending orbit;
a difference between switching intervals is lower than a threshold;
a difference between intra-orbit spacings is lower than a threshold;
a difference between inter-orbit spacings is lower than a threshold;
a difference between loads is lower than a threshold; or
the satellites in the satellite group are configured to establish an inter-satellite link.

12. The apparatus according to claim 8, wherein the plurality of satellites belongs to a same large constellation, each satellite group of the at least one satellite group has a same quantity of orbits and a same quantity of satellites in each orbit, a quantity of orbits of the large constellation is divisible by the quantity of orbits of each satellite group, and a quantity of satellites in each orbit of the large constellation is divisible by the quantity of satellites in each orbit of each satellite group.

13. The apparatus according to claim 8, wherein the quantity of orbits of the large constellation is M1, and the quantity of satellites in each of the M1 orbits is N1, wherein M1 and N1 are natural numbers; and a size of each of the at least one satellite group is M2×N2, wherein M1 mod M2=0, N1 mod N2=0, M2 represents the quantity of orbits of each satellite group, N2 represents the quantity of satellites in each orbit of each satellite group, and mod represents a modulo operation.

14. The apparatus according to claim 13, wherein a quantity of the at least one satellite group is (M1×N1)/(M2×N2)×2, wherein “×2” represents that a satellite in an ascending orbit and a satellite in a descending orbit belong to different satellite groups.

15. A second communication apparatus comprising:
at least one processor; and
one or more memories coupled to the at least one processor and storing programming instructions for execution by the at least one processor to:
obtain information indicating at least one satellite group and at least one ground area unit associated with the at least one satellite group; and
perform switching of a first communication apparatus between a plurality of satellites in a satellite group in the at least one satellite group based on the information, wherein the first communication apparatus is in a ground area unit associated with the satellite group.

16. The apparatus according to claim 15, wherein the at least one satellite group comprises an intra-orbit satellite group and an inter-orbit satellite group, satellites in the intra-orbit satellite group belong to a same orbit, and satellites in the inter-orbit satellite group belong to at least two different orbits.

17. The apparatus according to claim 15, wherein satellites in a satellite group in the at least one satellite group meet at least one of the following:
a difference between altitudes is lower than a threshold;
a difference between inclinations is lower than a threshold;
all satellites in the satellite group are in an ascending orbit or all satellites in the satellite group are in a descending orbit;
a difference between switching intervals is lower than a threshold;
a difference between intra-orbit spacings is lower than a threshold;
a difference between inter-orbit spacings is lower than a threshold;
a difference between loads is lower than a threshold; or
the satellites in the satellite group are configured to establish an inter-satellite link.

18. The apparatus according to claim 15, wherein the plurality of satellites belongs to a same large constellation, each satellite group of the at least one satellite group has a same quantity of orbits and a same quantity of satellites in each orbit, a quantity of orbits of the large constellation is divisible by the quantity of orbits of each satellite group, and a quantity of satellites in each orbit of the large constellation is divisible by the quantity of satellites in each orbit of each satellite group.

19. The apparatus according to claim 15, wherein the quantity of orbits of the large constellation is M1, and the quantity of satellites in each of the M1 orbits is N1, wherein M1 and N1 are natural numbers; and a size of each of the at least one satellite group is M2×N2, wherein M1 mod M2=0, N1 mod N2=0, M2 represents the quantity of orbits of each satellite group, N2 represents the quantity of satellites in each orbit of each satellite group, and mod represents a modulo operation.

20. The apparatus according to claim 19, wherein a quantity of the at least one satellite group is (M1×N1)/(M2×N2)×2, wherein “×2” represents that a satellite in an ascending orbit and a satellite in a descending orbit belong to different satellite groups.
